(19) United States
(12) Patent Application Publication
(10) Pub. No.: US 2026/0281336 A1
(43) Pub. Date: Sep. 17, 2026

(54) VIDEO DECODING METHOD, VIDEO CODING METHOD, STORAGE MEDIUM, ELECTRONIC DEVICE, AND PRODUCT

(71) Applicant: TENCENT TECHNOLOGY (SHENZHEN) COMPANY LIMITED, Shenzhen (CN)

(72) Inventors: Han ZHANG, Shenzhen (CN); Minhao TANG, Shenzhen (CN)

(73) Assignee: TENCENT TECHNOLOGY (SHENZHEN) COMPANY LIMITED, Shenzhen (CN)

(21) Appl. No.: 19/671,394

(22) Filed: May 8, 2026

Related U.S. Application Data
(63) Continuation of application No. PCT/CN2025/072061, filed on Jan. 13, 2025.

(30) Foreign Application Priority Data
Jan. 15, 2024 (CN) 202410060332.2

(51) Int. Cl. H04N 19/117; H04N 19/46; H04N 19/82

(52) U.S. Cl. CPC H04N 19/117; H04N 19/46; H04N 19/82

(57) ABSTRACT

A video decoding method, apparatus, and computer-readable storage medium for efficient adaptive loop filtering through conditional parameter transmission. The method acquires a video bitstream containing decoding indication information with filter flag bits indicating filter parameters including tap coefficients and nonlinear clipping indices. Based on flag bit values, tap coefficient information is determined. When the flag bit has a first preset value, filter parameters are inferred without bitstream transmission; when the flag bit has a second preset value, parameters are decoded from the bitstream. Adaptive loop filtering is performed on reconstructed pictures using configured filter parameters to generate filtered reference pictures for subsequent decoding. This conditional parameter signaling reduces bitstream overhead while maintaining filtering quality through intelligent parameter inference and selective transmission.

### CROSS-REFERENCE TO RELATED APPLICATIONS

This application is a continuation application of International Application No. PCT/CN2025/072061 filed on Jan. 13, 2025 which claims priority to Chinese Patent Application No. 202410060332.2, filed with the China National Intellectual Property Administration on Jan. 15, 2024, the disclosures of each being incorporated by reference herein in their entireties.

### FIELD

The disclosure relates to the field of video coding and decoding technologies, a video decoding method, a video coding method, a computer-readable storage medium, an electronic device, and a computer program product.

### BACKGROUND

A nonlinear clipping operation used by adaptive loop filtering (ALF) and an increasing quantity of filter taps improve the ALF quality, but necessitate transmission of more parameters to a decoding side, resulting in a problem of redundancy transmission, which is inconducive to improving coding and decoding performance.

### SUMMARY

Provided are a video decoding method and apparatus, a device, a storage medium, and a program product, which can implement efficient adaptive loop filtering through selective filter parameter transmission and inference based on flag bit signaling.

According to some embodiments, a video decoding method, performed by an electronic device, includes: acquiring a video bitstream including decoding indication information, wherein the decoding indication information includes at least one filter flag bit indicating a filter parameter of a filter, and wherein the filter parameter includes a tap coefficient and a nonlinear clipping index corresponding to the tap coefficient; determining, based on a value of the at least one filter flag bit, tap coefficient information about the filter parameter; determining the filter parameter based on the tap coefficient information, wherein: based on the at least one filter flag bit having a first preset value, the determining the filter parameter includes skipping receiving the tap coefficient information from the video bitstream and inferring at least a portion of the filter parameter, and based on the at least one filter flag bit having a second preset value different from the first preset value, the determining the filter parameter includes decoding the tap coefficient information from the video bitstream to obtain the at least the portion of the filter parameter; and performing adaptive loop filtering on a reconstructed picture using the filter configured by the filter parameter, to generate a filtered reconstructed picture for use as a reference picture in decoding a subsequent picture.

According to some embodiments, a video decoding apparatus, includes: at least one memory configured to store program code; and at least one processor configured to read the program code and operate as instructed by the program code, the program code including: acquisition code configured to cause at least one of the at least one processor to acquire a video bitstream including decoding indication information, wherein the decoding indication information includes at least one filter flag bit indicating a filter parameter of a filter, and wherein the filter parameter includes a tap coefficient and a nonlinear clipping index corresponding to the tap coefficient; first determination code configured to cause at least one of the at least one processor to determine, based on a value of the at least one filter flag bit, tap coefficient information about the filter parameter; second determination code configured to cause at least one of the at least one processor to determine the filter parameter based on the tap coefficient information, wherein: based on the at least one filter flag bit having a first preset value, the determining the filter parameter includes skipping receiving the tap coefficient information from the video bitstream and inferring at least a portion of the filter parameter, and based on the at least one filter flag bit having a second preset value different from the first preset value, the determining the filter parameter includes decoding the tap coefficient information from the video bitstream to obtain the at least the portion of the filter parameter; and filtering code configured to cause at least one of the at least one processor to perform adaptive loop filtering on a reconstructed picture using the filter configured by the filter parameter, to generate a filtered reconstructed picture for use as a reference picture in decoding a subsequent picture.

According to some embodiments, a non-transitory computer-readable storage medium, storing computer code which, when executed by at least one processor, causes the at least one processor to at least: acquire a video bitstream including decoding indication information, wherein the decoding indication information includes at least one filter flag bit indicating a filter parameter of a filter, and wherein the filter parameter includes a tap coefficient and a nonlinear clipping index corresponding to the tap coefficient; determine, based on a value of the at least one filter flag bit, tap coefficient information about the filter parameter; determine the filter parameter based on the tap coefficient information, wherein: based on the at least one filter flag bit having a first preset value, the determining the filter parameter includes skipping receiving the tap coefficient information from the video bitstream and inferring at least a portion of the filter parameter, and based on the at least one filter flag bit having a second preset value different from the first preset value, the determining the filter parameter includes decoding the tap coefficient information from the video bitstream to obtain the at least the portion of the filter parameter; and perform adaptive loop filtering on a reconstructed picture using the filter configured by the filter parameter, to generate a filtered reconstructed picture for use as a reference picture in decoding a subsequent picture.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

The foregoing and/or additional aspects and advantages of this application become apparent and easily understood from the description of embodiments with reference to the following drawings.

FIG. 1 is a schematic diagram of a video coding principle according to some embodiments.

FIG. 2 is a schematic diagram of an inter-picture prediction principle according to some embodiments.

FIG. 3 is a schematic structural diagram of a slice according to some embodiments.

FIG. 4 is a schematic diagram of a filtering principle of a versatile video coding filter according to some embodiments.

FIG. 5 is a schematic diagram of a shape of a filter according to some embodiments.

FIG. 6 is a schematic diagram of a shape of a filter according to some embodiments.

FIG. 7 is a block diagram of a video coding and decoding system according to some embodiments.

FIG. 8 to FIG. 16 are schematic flowcharts of a video decoding method according to some embodiments.

FIG. 17 is a schematic flowchart of a video coding method according to some embodiments.

FIG. 18 is a schematic structural diagram of a video decoding apparatus according to some embodiments.

FIG. 19 is a schematic structural diagram of a video coding apparatus according to some embodiments.

FIG. 20 is a schematic structural diagram of an electronic device according to some embodiments.

FIG. 21 is a schematic diagram of a hardware structure of an electronic device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Embodiments of this application are described below in detail. Examples of the embodiments are shown in the drawings, where the same or similar reference numerals denote the same or similar elements or elements having the same or similar functions. The embodiments described below with reference to the drawings are exemplary, and are merely used to explain this application, but cannot be understood as limitations to this application.

Some technical terms in this application are described below.

### 1. Video Coding:

In terms of signal acquiring modes, video signals may be classified into two types, namely, the video signals captured by a camera and the video signals generated by a computer. Due to differences in statistical characteristics, corresponding compression and coding modes may further differ.

Referring to FIG. 1, modern mainstream video coding technologies, using international video coding standards as an example, such as high efficiency video coding (HEVC/H.265), versatile video coding (VVC), and audio video coding standard (AVS3), adopt a hybrid coding framework to perform a series of the following operations and processing on an inputted original video signal:

(1) Block partition structure: an input video picture is partitioned into a plurality of non-overlapping processing units based on a size of one input video picture, and a similar compression operation is performed on each processing unit. This processing unit is referred to as a coding tree unit (CTU) or a largest coding unit (LCU). Further, the CTU may be further partitioned more finely to obtain one or more basic coding units, which are referred to as coding units (CU). Each CU is the most fundamental element in one coding process. The following describes various coding modes that may be employed for each CU.

(2) Predictive coding: predictive coding includes an intra-picture prediction mode, an inter-picture prediction mode (such as motion-comp prediction), and the like, and a residual video signal is obtained after an original video signal is predicted by using a selected reconstructed video signal. An encoding side may determine a most suitable predictive coding mode for the current CU from a plurality of possible predictive coding modes, and inform the decoding side of the selected one.

The mainstream video coding standards, such as HEVC, versatile video coding (VVC), audio video coding standard 3 (AVS3), alliance for open media video 1 (AV1) developed by the Open Media Alliance, and alliance for open media video 2 (AV2) developed by the Open Media Alliance, all use a block-based hybrid coding framework. In the mainstream video coding standards, original video data are divided into a series of coded blocks to implement video data compression in combination with video coding methods such as prediction, transformation, and entropy coding. Motion compensation, a prediction method in video coding, derives a prediction value of the current coded block from a coded region based on the temporal or spatial redundancy characteristics of video content. These prediction methods include inter-picture prediction, intra-picture block copy prediction, intra-picture string copy prediction, and the like. In coding implementations, these methods may be used individually or in combination. For a coded block using these prediction methods, one or more two-dimensional displacement vectors usually may be explicitly or implicitly coded in a bitstream, to indicate displacement of the current block (or a collocated block of the current block) relative to one or more reference blocks of the current block.

In different prediction modes and in different implementations, the displacement vector may have different names, and is collectively herein described in the following modes: (1) a displacement vector in inter-picture prediction is referred to as a motion vector (MV); (2) a displacement vector in intra-picture block copy is referred to as a block vector (BV); and (3) a displacement vector in intra-picture string copy is referred to as a string vector (SV). Technologies related to inter-picture prediction and intra-picture block copy prediction are described below.
a. Intra-picture prediction: a predicted signal is from a region that is already reconstructed by coding from the same picture.
b. Inter-picture prediction: a predicted signal is from another picture (referred to as a reference picture) that is already coded and that is different from the current picture.

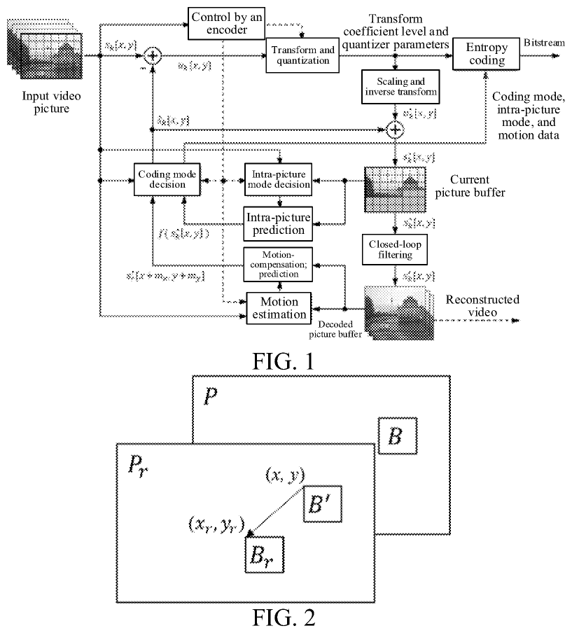

As shown in FIG. 2, inter-picture prediction uses correlation in a video time domain, and employs pixels of an adjacent coded picture to predict pixels of the current picture, to effectively remove video time-domain redundancy, and effectively save bits for coding residual data. P denotes a current frame, Pr denotes a reference frame, B denotes a current to-be-coded block, and Br denotes a reference block of B. A coordinate position of B′ is the same as that of B in the picture; the coordinates of Br are (xr, yr), and the coordinates of B′ are (x, y). The displacement between the current coded block and a reference block of the current coded block is referred to as a motion vector (MV), namely, MV=(xr−x, yr−y).

Considering that adjacent blocks in the time domain or the spatial domain have relatively strong correlation, an MV prediction technology may be employed to further reduce bits needed for coding the MV. In H.265/HEVC, inter-picture prediction includes two MV prediction technologies: merge and advanced motion vector prediction (AMVP).

(3) transformation coding and quantization: transformation operations such as discrete Fourier transform (DFT) and discrete cosine transform (DCT) are performed on a residual video signal, and the signal is transformed into a transformation domain, which is referred to as a transformation coefficient. Lossy quantization is further performed on the signal in the transformation domain, to lose some information, so that a quantized signal is beneficial for compression and expression. In some video coding standards, more than one transformation mode may be selected. Therefore, the encoding side further may select one transformation mode for the current CU, and inform the decoding side of the selected transformation mode. Quantization fineness is usually determined by a quantizer parameter (QP). A larger value of the QP indicates that coefficients within a larger value range are quantized into the same output. Therefore, larger distortion and a lower bit rate are usually caused. On the contrary, a smaller value of the QP indicates that the coefficients within a smaller value range are quantized into the same output. Therefore, smaller distortion and a corresponding higher bit rate may be caused.

(4) Entropy coding or statistical coding: statistical compression and coding are performed on a quantized transformation-domain signal based on an occurrence frequency of each value, and finally, a binary (0 or 1) compressed bitstream is outputted. Meanwhile, entropy coding further may be performed on other information generated by coding such as a selected mode or a motion vector, to reduce the bit rate. The statistical coding is a lossless coding mode, which can effectively reduce the bit rate to express the same signal. A common statistical coding mode includes variable length coding (VLC) or context-adaptive binary arithmetic coding (CABAC).

(5) Loop filtering: operations such as inverse quantization (scaling and inverse transformation), inverse transformation, and predictive compensation (reverse operations in (2) to (4)) are performed on a coded picture to obtain a reconstructed decoded picture. Compared with the original picture, due to a quantization impact, some information of the reconstructed picture is different from the original picture, resulting in distortion. A filtering operation is performed on the reconstructed picture, such as deblocking filtering, sample adaptive offset (SAO), or ALF, to effectively reduce a distortion degree caused by quantization. Because these filtered reconstructed pictures are used as a reference for subsequently coded pictures and configured for predicting future signals, the foregoing filtering operation is further referred to as loop filtering and a filtering operation inside a coding loop.

2. Video decoding: video decoding is a reverse process of video coding. Based on the foregoing coding process, it may be seen that, on the decoding side, for each CU, a decoder first performs entropy decoding on an obtained video bitstream, to obtain various types of mode information and quantized transformation coefficients. Inverse quantization and inverse transformation are performed on each coefficient, to obtain a residual signal. Furthermore, based on known coding mode information, a prediction signal corresponding to the CU may be obtained, and a reconstructed signal may be obtained by adding the prediction signal and the residual signal. Finally, a loop filtering operation may be performed on a reconstructed value of the decoded picture, to generate a final output signal.

### 3. Video Bitstream Structure

### (1) Video Sequence

A video sequence is a top-level syntax structure of a bitstream (i.e., a video bitstream). The video sequence starts from a first sequence header, and a sequence end code or a video editing code represents the end of one video sequence. The sequence header from the first sequence header of the video sequence to the sequence end code or the video editing code appearing first is a repeated sequence header. Each sequence header is followed by one or more coded pictures, and each picture is to be preceded by a picture header. The coded pictures are sorted in the bitstream based on a bitstream order, and the bitstream order may be the same as a decoding order. The decoding order may be different from a display order.

### (2) Picture

A picture may be a frame or a field, and coded data of the picture begins with a picture start code and ends at a sequence start code, a sequence end code, or a next picture start code.

Picture types include I-pictures; P-pictures; B-pictures. A fully coded frame is referred to as an I-frame. A frame generated with reference to a previous I-frame and coding only differences is referred to as a P-frame. Additionally, a frame that is coded with reference to both previous and following frames is referred to as a B-frame.

### (3) Slice

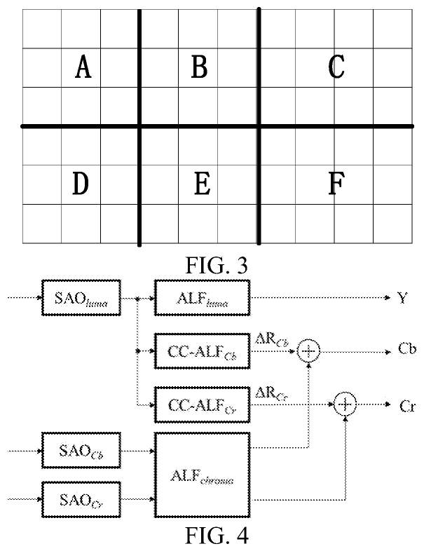

A slice is a rectangular region (such as a region A and a region B) in a picture that includes parts of several largest coding units in the picture. Slices are not to overlap with each other. A slice structure is shown in FIG. 3.

### (4) Largest Coding Unit, Coding Tree, and Coding Unit

A picture is partitioned into largest coding units (such as coding tree units (CTUs) in video coding). The largest coding units do not overlap with each other. A sample at an upper left corner of the largest coding unit is not to go beyond a picture boundary, and a sample at a lower right corner of the largest coding unit may go beyond the picture boundary.

The coding tree determines a partitioning mode for partitioning the largest coding unit into a plurality of coding units (such as CUs in video coding), such as a binary tree partitioning mode, a quadtree partitioning mode, and an enhanced quadtree partitioning mode. One coding unit may serve as one picture block.

The coding unit is partitioned into one or more transformation blocks, and a transformation block is a fundamental unit for transformation coding.

### 4. ALF and Cross-Component Adaptive Loop Filtering (CCALF) in Versatile Video Coding (VVC)

As newly adopted loop filters in the VVC, the ALF and the CCALF are Wiener filters, and adaptively determine filter coefficients based on different video content, to reduce a mean square error (MSE) between a reconstructed component and an original component. An input of the ALF is a reconstructed pixel value before ALF processing, and an output of the ALF is an enhanced reconstructed luminance picture and an enhanced reconstructed chrominance picture. As an adaptive filter, the Wiener filter may generate different filter coefficients for video content with different characteristics. Therefore, the ALF may first classify the video content, and employs a corresponding filter for each class of video content. In a design of the VVC, each 4×4 block may be classified into one of 25 classes based on directionality and activity of the 4×4 block. The corresponding filter coefficient may be calculated for each class of video content.

For a luminance component, in addition to 4×4 block-level adaptivity, the VVC further supports CTU-level ALF adaptive switching. Each CTU may employ a filter bank generated by a current slice or may employ a filter bank generated by a coded slice, or a set of fixed filters in 16 fixed filter banks that are trained offline. Inside the CTU, each 4×4 block may select a corresponding type of filter from the filter bank based on a type of the 4×4 block for filtering. A filter coefficient of an adaptation parameter set (APS) and a corresponding clipping index are transmitted from the ALF_APS to the decoding side. One ALF_APS may include one luminance filter bank (including a maximum of 25 filters) and a maximum of 8 chrominance filters.

The CCALF employs the luminance component to correct the chrominance component. A processing procedure of the ALF and the CCALF is shown in FIG. 4. The CCALF uses the luminance component as an input, and outputs a corrected value of the chrominance component. The two chrominance components may be independently controlled to determine whether to use corresponding corrected values. The corrected value and an output of the chrominance ALF jointly form a final chrominance component.

### 4.1 ALF Filter Shape

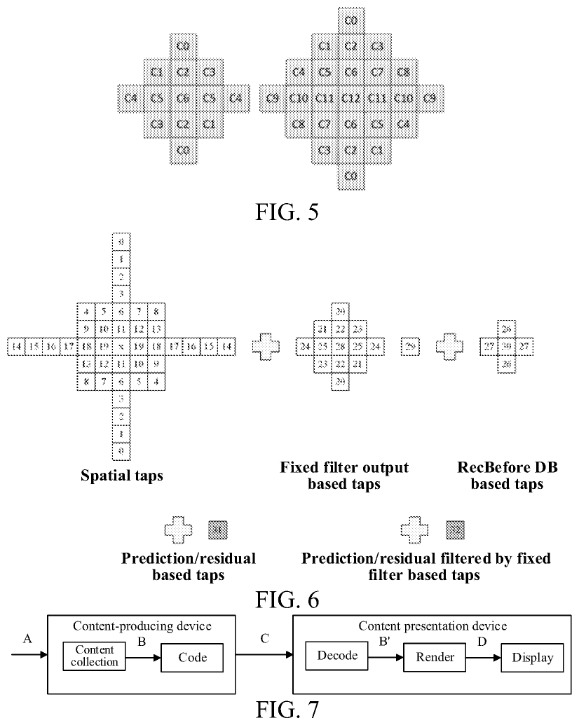

In the VVC [1], the ALF uses two different diamond-shaped filters, as shown in FIG. 5. The luminance component employs a 7×7 diamond-shaped filter, and the chrominance component employs a 5×5 diamond-shaped filter.

### 4.2 Pixel Block Classification and Geometric Transformation

For the luminance component, the ALF may adaptively employ different filters at a sub-block level (4×4). To be specific, each 4×4 pixel block may be classified into one of 25 classes. For the chrominance component, the ALF does not may classify the sub-block-level pixels, and all chrominance pixels in one CTU use the same filter. A classification index C of the luminance component pixel block is derived from directionality D of the block together with quantized activity Â. A formula is as follows:

$$C = 5 D + \hat{A} \qquad \# ( 2 ‐ 1 )$$

To calculate D and Â, horizontal, vertical, diagonal, and anti-diagonal gradient values for each pixel in the 4×4 pixel block may be calculated first:

$${H}_{k , l} = \vert 2 R ( k , l ) - R ( k - 1 , l ) - R ( k + 1 , l ) \vert \qquad \# ( 2 ‐ 2 )$$

$${V}_{k , l} = \vert 2 R ( k , l ) - R ( k , l - 1 ) - R ( k , l + 1 ) \vert \qquad \# ( 2 ‐ 3 )$$

$$D {0}_{k , l} = \vert 2 R ( k , l ) - R ( k - 1 , l - 1 ) - R ( k + 1 , l + 1 ) \vert \qquad \# ( 2 ‐ 4 )$$

$$D {1}_{k , l} = \vert 2 R ( k , l ) - R ( k - 1 , l + 1 ) - R ( k + 1 , l - 1 ) \vert \qquad \# ( 2 ‐ 5 )$$

Based on pixel gradients, overall horizontal, vertical, diagonal, and anti-diagonal gradients of each 4×4 block are calculated as follows:

$${g}_{h} = {\sum }_{k = i - 2}^{i + 5} {\sum }_{l = j - 2}^{j + 5} {H}_{k , l} , {g}_{v} = {\sum }_{k = i - 2}^{i + 5} {\sum }_{l = j - 2}^{j + 5} {V}_{k , l} \qquad \# ( 2 ‐ 6 )$$

$${g}_{d 0} = {\sum }_{k = i - 2}^{i + 5} {\sum }_{l = j - 2}^{j + 5} D {0}_{k , l} , {g}_{d 1} = {\sum }_{k = i - 2}^{i + 5} {\sum }_{l = j - 2}^{j + 5} D {1}_{k , l} \qquad \# ( 2 ‐ 7 )$$

where i and j denote coordinates of an upper-left pixel of the 4×4 pixel block, and R(k,l) denotes a reconstructed pixel value at a position (k,l) before ALF filtering is performed.

After the gradient values of the pixel block are obtained, a maximum value and a minimum value of the gradient values in the horizontal and vertical directions are respectively as follows:

$${g}_{h , v}^{max} = max ( {g}_{h} , {g}_{v} ) , {g}_{h , v}^{min} = min ( {g}_{h} , {g}_{v} ) \qquad \# ( 2 ‐ 8 )$$

A maximum value and a minimum value of the gradient values in the diagonal and anti-diagonal directions are respectively as follows:

$${g}_{d 0 , d 1}^{max} = max ( {g}_{d 0} , {g}_{d 1} ) , {g}_{d 0 , d 1}^{min} = min ( {g}_{d 0} , {g}_{d 1} ) \qquad \# ( 2 ‐ 9 )$$

The directionality D is derived by comparing the maximum value and the minimum value of the gradient values in four directions obtained from formulas (2-8) to (2-9).

Operation 1: If

$${g}_{h , v}^{max} \leq {t}_{1} \cdot {g}_{h , v}^{min} and {g}_{d 0 , d 1}^{max} \leq {t}_{1} \cdot {g}_{d 0 , d 1}^{min} ,$$

### set D to 0.

Operation 2: If

$${g}_{h , v}^{max} / {g}_{h , v}^{min} > {g}_{d 0 , d 1}^{max} / {g}_{d 0 , d 1}^{min} ,$$

perform operation 3; and otherwise, perform operation 4.

Operation 3: If

$${g}_{h , v}^{max} > {t}_{2} \cdot {g}_{h , v}^{min} ,$$

set D to 2; and otherwise, set D to 1.

Operation 4: If

$${g}_{d 0 , d 1}^{max} > {t}_{2} \cdot {g}_{d 0 , d 1}^{min} ,$$

set D to 4; and otherwise, set D to 3.

The activity A is calculated by using the following formula:

$$A = {\sum }_{k = i - 2}^{i + 5} {\sum }_{l = j - 2}^{j + 5} ( {V}_{k , l} + {H}_{k , l} ) \qquad \# ( 2 - 10 )$$

The activity A may be quantized to a range [0-4], resulting in quantized activity Â.

Before each 4×4 luminance block is filtered, geometric transformation including no transformation, diagonal transformation, vertical flip, and rotation transformation may be performed on the filter coefficient and a corresponding clipping value based on the gradient value of the current block and based on rules in Table 2-1. Applying geometric transformation to the filter coefficient is equivalent to applying geometric transformation to the pixel values and then filtering them, while keeping the coefficient unchanged. An objective of the geometric transformation is to align the directionality of different block content as much as possible, to reduce a quantity of classes by the ALF, enabling different pixels to share the same filter coefficient. Using the geometric transformation may increase actual classes from 25 to 100 without increasing the quantity of ALF filters, thereby improving self-adaptability.

TABLE 2-1
Geometric transformation based on pixel block gradient values

| Gradient value | Geometric transformation |
|---|---|
| g_{d1} < g_{d0} and gₕ < gᵥ | No transformation |
| g_{d1} < g_{d0} and gᵥ ≤ gₕ | Diagonal transformation |
| g_{d0} ≤ g_{d1} and gₕ < gᵥ | Vertical flip |
| g_{d0} ≤ g_{d1} and gᵥ ≤ gₕ | Rotation transformation |

### 4.3 ALF Filtering Process in the VVC

On the decoding side, if a CTU-level ALF flag is true, each pixel R(i, j) in the current CTU may be filtered, and a filtering process and an output are as follows:

$${R}^{′} ( i , j ) = R ( i , j ) + ( ( {\sum }_{k \neq 0} {\sum }_{l \neq 0} f ( k , l ) \times K ( R ( i + k , j + l ) - R ( i , j ) , c ( k , l ) ) + 64 ) >> 7 ) \qquad \# ( 2 ‐ 11 )$$

where f(k,l) denotes a filter tap coefficient, K(x, y) denotes a clipping function, and c(k, l) denotes a parameter related to a clipping operation. A value range of k and l is

$$- \frac{L}{2} to \frac{L}{2} ,$$

where L denotes a length of the filter. A definition of the clipping function is K(x, y)=min(y, max(−y,x)). The clipping operation adds a nonlinear function to the ALF, which may reduce an impact of peripheral pixels with large differences on the current pixel.

### 5. ALF in an Enhanced Compression Model (ECM) 8.0

The ECM-8.0 [2] removes a downsampling operation and virtual boundary restrictions in gradient computation during ALF classification process. Meanwhile, a fundamental unit for an ALF classification operation is changed from a 4×4 sub-block to a 2×2 sub-block. In addition, the shapes of the luminance filter and the chrominance filter are further changed correspondingly.

### 5.1. Enhanced Fixed Filter

For the luminance component, the ECM-8.0 employs three different classifiers (C0, C1, and C2) and three different filter banks (F0, F1, and F2). The filter banks F0 and F1 include fixed filters, and coefficients of the fixed filters are generated by offline training with the classifiers C0 and C1. The filter bank F2 includes a filter coefficient that is generated from to-be-coded content and may be written into the bitstream for transmission to the decoding side.

### 5.2 Classification Process

In the ECM-8.0, each 2×2 sub-block may generate a corresponding class index Cᵢ based on the directionality Dᵢ and the activity Aᵢ, as shown in the following formula:

$${C}_{i} = {\hat{A}}_{i} * {M}_{D , i} + {D}_{i} \qquad \# ( 2 ‐ 12 )$$

where i denotes a classifier index, M_{D,i} denotes a total quantity of directionality Dᵢ used by the corresponding classifier.

Similar to a computation process in the VVC, horizontal, vertical, diagonal, and anti-diagonal gradients of each pixel are generated by using a 1-D Laplace operator. For the classifier C₀, the gradient of its sub-block is generated by adding the pixel gradient values at all positions in a 4×4 region covering the target 2×2 sub-block. For the classifiers C1 and C2, the gradients of their sub-blocks are generated by adding pixel gradient values at all positions in a 12×12 region covering the target 2×2 sub-block. The horizontal, vertical, diagonal, and anti-diagonal sub-block gradients are specified as

$${g}_{h}^{i} , {g}_{v}^{i} , {g}_{d 1}^{i} , and {g}_{d 2}^{i} ,$$

and the directionality Dᵢ is obtained by comparing the following two values with a group of thresholds:

$${r}_{h , v}^{i} = \frac{max ( {g}_{h}^{i} , {g}_{v}^{i} )}{min ( {g}_{h}^{i} , {g}_{v}^{i} )} , {r}_{d 1 , d 2}^{i} = \frac{max ( {g}_{d 1}^{i} , {g}_{d 2}^{i} )}{min ( {g}_{d 1}^{i} , {g}_{d 2}^{i} )}$$

The directionality D₂ uses the same thresholds 2 and 4.5 as the VVC. For D₀ and D1, the horizontal/vertical edge strength

$${E}_{H V}^{i}$$

and diagonal edge strength

$${E}_{D}^{i}$$

are computed first. The threshold Th=[1.25,1.5,2,3,4.5,8] is used. When

$${r}_{h , v}^{i} > Th [ {E}_{H V}^{i} - 1 ] .$$

the edge strength

$${r}_{h , v}^{i} \leq T h [ 0 ] ,$$

is set to 0; and otherwise,

$${E}_{H V}^{i}$$

is a maximum integer satisfying

$${E}_{H V}^{i}$$

### When

$${r}_{d 1 , d 2}^{i} \leq T h [ 0 ] ,$$

the edge strength

$${E}_{D}^{i}$$

is set to 0; and otherwise,

$${E}_{D}^{i}$$

is a maximum integer satisfying

$${r}_{d 1 , d 2}^{i} > T h [ {E}_{D}^{i} - 1 ] .$$

### When

$${r}_{h , v}^{i} > {r}_{d 1 , d 2}^{i} ,$$

namely, when a horizontal/vertical or diagonal edge is dominant, the directionality Dᵢ is generated based on Table 2-2 (a). Otherwise, the directionality Dᵢ is generated based on Table 2-2 (b).

TABLE 2-2
$Mapping relationship between edge strengths {E}_{D}^{i} / {E}_{HV}^{i} and {D}_{i} .$

| | (a) | | | | | | | | (b) | | | | | | |
|---|---|---|---|---|---|---|---|---|---|---|---|---|---|---|---|
| | ${E}_{D}^{i}$ | | | | | | | | ${E}_{HV}^{i}$ | | | | | | |
| ${E}_{HV}^{i}$ | 0 | 1 | 2 | 3 | 4 | 5 | 6 | ${E}_{D}^{i}$ | 0 | 1 | 2 | 3 | 4 | 5 | 6 |
| 0 | 0 | 0 | 0 | 0 | 0 | 0 | 0 | 0 | 28 | 0 | 0 | 0 | 0 | 0 | 0 |
| 1 | 1 | 2 | 0 | 0 | 0 | 0 | 0 | 1 | 29 | 30 | 0 | 0 | 0 | 0 | 0 |
| 2 | 3 | 4 | 5 | 0 | 0 | 0 | 0 | 2 | 31 | 32 | 33 | 0 | 0 | 0 | 0 |
| 3 | 6 | 7 | 8 | 9 | 0 | 0 | 0 | 3 | 34 | 35 | 36 | 37 | 0 | 0 | 0 |
| 4 | 10 | 11 | 12 | 13 | 14 | 0 | 0 | 4 | 38 | 39 | 40 | 41 | 42 | 0 | 0 |
| 5 | 15 | 16 | 17 | 18 | 19 | 20 | 0 | 5 | 43 | 44 | 45 | 46 | 47 | 48 | 0 |
| 6 | 21 | 22 | 23 | 24 | 25 | 26 | 27 | 6 | 49 | 50 | 51 | 52 | 53 | 54 | 55 |

The activity Âᵢ is generated by quantizing an accumulated sum Aᵢ of horizontal and vertical gradients at the sub-block level, with a quantized value ranging from 0 to n. For Â₂, n is set to Â₀; and for Â₀ and Â₁, n is set to 15. One ALF_APS may transmit a maximum of four groups of luminance component filters, and each filter bank includes a maximum of 25 filters.

### 5.3. Band Classifier Based on 2×2 Sub-Blocks

In the ECM-8.0, one newly added classifier is used in an ALF classification process. For a group of filter banks transmitted to the decoding side, a flag bit is employed to indicate whether an original classifier or a new classifier is used. The new classifier cannot use geometric transformation. When the new classifier is used, pixels at all positions in one 2×2 sub-block are added, and then classification is performed based on a sum of the pixel values.

$${class}_{i n d e x} = ( sum \times 25 ) >> ( sample bitdepth + 2 ) \qquad \# ( 2 ‐ 13 )$$

### 5.4 Filtering Process

First, two fixed filters F₀ and F₁ using 13×13 diamond-shaped filters may generate two intermediate values R₀(x, y) and R₁(x,y) for the current to-be-filtered pixel. Then, the filter F₂ generated online may be applied to R₀(x, y), R₁(x, y), and surrounding pixels to generate filtered pixels, as shown in the following formula:

$$\tilde{R} ( x , y ) = R ( x , y ) + [ {\sum }_{i = 0}^{19} {c}_{i} ( {f}_{i , 0} + {f}_{i , 1} ) ] + [ {\sum }_{i = 20}^{21} {c}_{i} {g}_{i} ] \qquad \# ( 2 ‐ 14 )$$

where f_{i,j} denotes a difference between the surrounding pixels on which a clipping operation is performed and the current pixel R(x, y), and gᵢ denotes a difference between Rᵢ₋₂₀(x, y) on which the clipping operation is performed and the current pixel. The filter coefficient cᵢ, i=0, . . . 21, may be transmitted to the decoding side.

In the ECM-8.0, the luminance filter generated by online training includes four types of inputs in total: a spatial-domain neighboring sample, a reconstructed sample before deblocking, an extended sample generated by the fixed filter, and a residual component. A shape of the luminance filter is shown in FIG. 6. #0 to #19 denote spatial-domain neighboring samples, #20 to #25 and #28 to #29 denote samples generated by the fixed filter, #26, #27, and #30 denote the reconstructed samples before deblocking, and #31 and #32 denote the residual components. Based on the multiple types of inputs, a filtering process is shown as follows:

$$\tilde{R} ( x , y ) = R ( x , y ) + [ {\sum }_{i = 0}^{19} {c}_{i} ( {f}_{i , 0} + {f}_{i , 1} ) ] + [ {\sum }_{i = 20}^{25} {c}_{i} ( {g}_{i , 0} + {g}_{i , 1} ) ] + [ {\sum }_{i = 26}^{27} {c}_{i} ( {h}_{i , 0} + {h}_{i , 1} ) ] + [ {\sum }_{i = 28}^{29} {c}_{i} {g}_{i} ] + [ {\sum }_{i = 30}^{30} {c}_{i} {h}_{i} ] + [ {\sum }_{i = 31}^{31} {c}_{i} {r}_{i} ] + [ {\sum }_{i = 32}^{32} {c}_{i} {rFilterd}_{i} ] \qquad ( 2 ‐ 15 )$$

where f_{i,j} denotes a difference between a clipped pixel sample around a spatial domain and the current sample R(x, y), gᵢ denotes a difference between a clipped pixel sample generated by the fixed filter and the current sample R(x, y), and h_{i,j} denotes a difference between the clipped reconstructed sample before deblocking and the current sample R(x, y). rᵢ denotes a clipped residual component. rFilteredᵢ denotes a clipped residual component generated by the fixed filter. The residual component and the reconstructed component employ the same fixed filter.

In the ALF_APS, one flag bit is used to indicate whether to use only the residual component or both the residual component and the residual component filtered by the fixed filter.

### 5.5. Classifier Based on the Residual Component

A classifier based on the luminance residual component is used as a third classifier of the ALF. For any 2×2 luminance sub-block, a sum sum of absolute values of the residual components is first computed for all positions in a 8×8 region covering the current 2×2 sub-block. Then based on the accumulated sum, classification is performed by using the following formula:

$$classIdx = sum >> ( sample bit depth - 4 ) \qquad \# ( 2 ‐ 16 )$$

A value of a final class classIdx ranges from 0 to 24. In the ALF_APS, the used classifier may be transmitted for each filter bank.

### 5.6. ALF Coefficient and Non-Linear Clipping Index Transmission Process.

For the current to-be-filtered picture, the ALF coefficient may be selected from a filter coefficient generated from the current picture, a filter coefficient generated from the coded picture, and a pre-trained filter coefficient. If the filter coefficient generated from the current picture is selected, a filter-related parameter may be transmitted to the decoding side. One exemplary ALF filter syntax element and its transmission process are shown in Table 1:

| | Descriptor |
|---|---|
| alf_data( ) { | |
| ... | |
| if( alf_comp_filter_signal_flag ) { | |
| ... | |
| alf_comp_num_alt_filters_minus1 | ue(v) |
| for(altIdx = 0; altIdx <= alf_comp_num_alt_filters_minus1; altIdx++){ | |
| alf_comp_clip_flag | u(1) |
| alf_comp_num_filters_signalled_minus1 | ue(v) |
| ... | |
| for( sfIdx = 0; sfIdx <= alf_comp_num_filters_signalled_minus1; | |
| sfIdx++ ) | |
| alf_comp_coeff( ) | |
| if( alf_comp_clip_flag ) | |
| for( sfIdx = 0; sfIdx <= alf_comp_num_filters_signalled_minus1; | |
| sfIdx++ ) | |
| for( j = 0; j < filter_tap_num; j++ ) | |
| alf_comp_clip_idx[altIdx][ sfIdx ][ j ] | u(2) |
| ... | |
| } | |
| } | |
| } | |

alf_comp_num_alt_filters_minus1+1 denotes a quantity of filter banks used for a current color component (such as a luminance component, a chrominance component, or a cross-component). In the ECM, the luminance component supports a maximum of 4 filter banks, and the chrominance component supports a maximum of 8 filter banks). For each filter bank, whether a filter included in the current filter bank uses nonlinear clipping may be indicated by using alf_comp_clip_flag.

A

If_comp_num_filters_signalled_minus1+1 denotes a quantity of filters included in the current filter bank (in the ECM, one filter bank for the luminance component includes a maximum of 25 filters, and one filter bank for the chrominance component includes at most 1 filter. The syntax element does not may be transmitted for the chrominance component).

alf_comp_coeff ( ) denotes transmission of a filter tap coefficient. If nonlinear clipping is used, a nonlinear clipping index alf_comp_clip_idx [altIdx] [sfIdx] [j] may be transmitted for each tap coefficient of the filter.

The video decoding method and the video coding method provided in the embodiments of this application may be applied to a video coding and decoding system. The video coding and decoding system may include a content-producing device (corresponding to a coding device) and a content presentation device (corresponding to a decoding device). The content-producing device may be an electronic device used by a provider of the video data (such as a content maker of the video data). The electronic device may be a terminal (such as a personal computer (PC) or an intelligent mobile device (such as a smartphone)) or a server.

The server may be an independent physical server, a server cluster or a distributed system including a plurality of physical servers, or a cloud server providing basic cloud computing services such as a cloud service, a cloud database, cloud computing, a cloud function, cloud storage, a network service, cloud communication, a middle-ware service, a domain name service, a security service, a content distribution network (CDN), and a big data and artificial intelligence platform. The content presentation device may refer to an electronic device used by a user of the video data (such as a viewer of the video data, i.e., a service object). The electronic device may be a terminal (such as a personal computer (PC), an intelligent mobile device (such as a smartphone), a virtual reality (VR) device (such as a VR helmet and VR glasses), a smart appliance, an in-vehicle terminal, or an aircraft). A client is integrated into the electronic device.

The client herein may be a client having a function of displaying data information such as text, pictures, audio, and video, and includes, but is not limited to, a multimedia client (such as a video client), a social client (such as an instant messaging client), an information application (such as a news client), an entertainment client (such as a game client), a shopping client, an in-vehicle client, a browser, and the like. The client may be an independent client, or may be an embedded sub-client integrated in a client (such as a social client). This is not limited herein.

The content-producing device and the content presentation device may be the same device, or may be different devices, and both include multiple modules. Different modules are configured to implement different functions. These modules may be integrated into the same electronic device, or may be located in different electronic devices. The content-producing device may be configured to implement functions such as acquisition and coding of the video data. Correspondingly, the content presentation device may be configured to implement functions such as decoding, rendering, and display of an encapsulated file. FIG. 7 is a block diagram of a video coding and decoding system of video data according to some embodiments.

In FIG. 7, on a content-producing device side, a real-world visual scene is captured and collected by a group of cameras or a camera device having a plurality of lenses and sensors. A collected picture A captured by the camera is video data B, and the video data B includes a plurality of frames of captured pictures. On the content-producing device side, a plurality of frames of screen content pictures A may be used as the video data B. After content is collected, the video data B is coded to obtain a video bitstream C, and the video bitstream C is transmitted to the content presentation device.

The content presentation device decodes the video bitstream C to obtain decoded video data B′, and then renders the decoded video data B′ to obtain a rendered video D, thereby performing display based on the video D.

The coding and decoding technology involved in this application may be implemented by using a cloud technology. For example, a cloud server serves as the content-producing device. The cloud technology refers to a hosting technology that unifies a series of resources such as hardware, software, and a network in a wide area network or a local area network, to implement data computing, storage, processing, and sharing.

Based on the foregoing basic concepts and descriptions of related scenes, embodiments of this application provide a video coding method, a video decoding method, a video coding apparatus, a video decoding apparatus, a computer storage medium, and an electronic device.

To support the video coding method in the embodiments of this application, in some embodiments of this application, based on the related art, a plurality of descriptive fields are added at a system level to define a corresponding high-level syntax data structure. In the following content, the foregoing video coding method is described in detail with reference to various syntax tables.

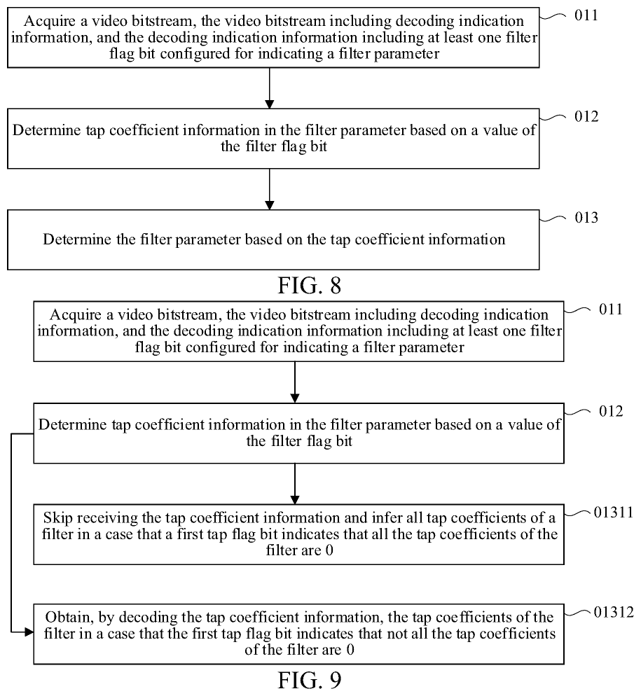

Referring to FIG. 8, a video decoding method provided in some embodiments of this application includes the following operations:

Operation 011: Acquire a video bitstream, the video bitstream including decoding indication information, and the decoding indication information including at least one filter flag bit configured for indicating a filter parameter.

After video data (such as at least one of a picture captured by a camera or a screen content picture generated by a computer) is coded and compressed, a bitstream, i.e., a video bitstream may be obtained.

A decoding side may acquire the video bitstream transmitted by an encoding side. The video bitstream includes the decoding indication information, and the decoding side may decode the video bitstream based on the decoding indication information.

The decoding indication information is configured for providing decoding indication for different data in the video bitstream. The decoding indication information includes a video sequence, and the video sequence is a top-level syntax structure of the video bitstream.

The decoding indication information includes at least one filter flag bit configured for indicating the filter parameter, and the filter flag bit is configured for providing decoding indication for the filter parameter.

In some embodiments, the filter parameter may include a tap coefficient and a nonlinear clipping index corresponding to the tap coefficient. The filter parameter includes a parameter whose value is repeated or whose value is a preset value (such as 0). If the parameter is transmitted, a large amount of redundant data may be generated (for example, a plurality of the same nonlinear clipping indexes are transmitted). Therefore, decoding indication may be performed on the filter parameter by using the filter flag bit, thereby facilitating the reduction of redundant data.

Operation 012: Determine tap coefficient information in the filter parameter based on a value of the filter flag bit.

The tap coefficient information is configured for representing information related to the tap coefficient of the filter (such as the tap coefficient and a nonlinear clipping index corresponding to the tap coefficient), for example, whether the tap coefficients of the filter are all 0, and whether all the nonlinear clipping indexes corresponding to the tap coefficients are the same.

Specifically, when decoding indication is performed by using the filter flag bit, the tap coefficient information in the filter parameter may be determined by decoding a value of the filter flag bit to determine information related to the tap coefficients of the filter, thereby facilitating subsequent decoding to obtain the corresponding filter parameter based on the information related to the tap coefficients.

For example, based on the value of the filter flag bit, it is determined that the tap coefficient information in the filter parameter indicates that the tap coefficients of the filter are all 0; or based on the value of the filter flag bit, it is determined that the tap coefficient information in the filter parameter indicates that all the nonlinear clipping indexes corresponding to the tap coefficients are the same.

Operation 013: Determine the filter parameter based on the tap coefficient information.

After the tap coefficient information is determined, the corresponding filter parameter may be obtained by decoding the tap coefficient information.

For example, in a case that it is determined that the tap coefficient information indicates that the tap coefficients of the filter are all 0, it may be inferred that the tap coefficients of the filter are all 0. For another example, in a case that it is determined that the tap coefficient information indicates that all the nonlinear clipping indexes corresponding to the tap coefficients are the same, it may be inferred that the nonlinear clipping indexes corresponding to the tap coefficients of the filter are preset indexes.

In this way, the filter flag bit is introduced into high-level syntax (i.e., the decoding indication information) of video coding and decoding to perform decoding indication for the filter parameter (such as the filter parameter corresponding to the tap coefficient information) that may generate redundant data during transmission, so that the filter parameter that may generate the redundant data does not may be transmitted in the video bitstream, and implicit transmission of the filter parameter is implemented, which is conducive to reducing the bit rate of the video bitstream and improving coding and decoding performance.

Referring to FIG. 9, in some implementations, the filter flag bit includes a first tap flag bit, and the first tap flag bit is configured for indicating whether all the tap coefficients of a corresponding filter are 0. In a case that the first tap flag bit is a first preset value, it is determined that the tap coefficient information indicates that all the tap coefficients of the filter are 0. In a case that the first tap flag bit is a second preset value, it is determined that the tap coefficient information indicates that not all the tap coefficients of the filter are 0, and the first preset value is different from the second preset value. In operation 013, the determining the filter parameter based on the tap coefficient information includes:

Operation 01311: Skip receiving the tap coefficient information and infer all tap coefficients of a filter in a case that the first tap flag bit indicates that all the tap coefficients of the filter are 0.

Operation 01312: Obtain, by decoding the tap coefficient information, the tap coefficients of the filter in a case that the first tap flag bit indicates that not all the tap coefficients of the filter are 0. The first preset value is different from the second preset value.

Specifically, in an existing design, even in a case that all the tap coefficients of one filter are 0, all the tap coefficients still may be transmitted for the filter, resulting in significant redundancy in the transmitted tap coefficients. Therefore, the first tap flag bit may be set in the filter flag bit to indicate whether all the tap coefficients of the filter are 0.

In a case that the first tap flag bit is the first preset value, it may indicate that all the tap coefficients of the filter are 0, so that it may be determined that all the tap coefficients of the filter are redundant data, and all the tap coefficients of the filter may be implicitly transmitted. To be specific, the encoding side does not transmit the tap coefficient information (i.e., all the tap coefficients of the filter), and the decoding side does not may receive the tap coefficient information. The decoding side may directly infer that all the tap coefficients of the filter are 0 in a case that the first tap flag bit is the first preset value.

However, in a case that the first tap flag bit is the second preset value, it may indicate that not all the tap coefficients of the filter corresponding to the first tap flag bit are 0. In this case, there is no redundant data during transmission of these tap coefficients of the filter. Therefore, all the tap coefficients of the filter may be explicitly transmitted, and the decoding side may obtain the tap coefficients transmitted in the filter by decoding the tap coefficient information (i.e., the explicitly transmitted tap coefficients).

The first preset value may be 1, and the second preset value may be 0; or the first preset value may be 0, and the second preset value may be 1.

In one example, a transmission process of a syntax element corresponding to the first tap flag bit is shown in the following Table 2:

| | Descriptor |
|---|---|
| alf_data( ) { | |
| ... | |
| if( alf_comp_filter_signal_flag ) { | |
| ... | |
| alf_comp_num_alt_filters_minus1 | ue(v) |
| for(altIdx = 0; altIdx <= alf_comp_num_alt_filters_minus1; altIdx++){ | |
| alf_comp_clip_flag | u(1) |
| alf_comp_num_filters_signalled_minus1 | ue(v) |
| ... | |
| for( sfIdx = 0; sfIdx <= alf_comp_num_filters_signalled_minus1; | |
| sfIdx++ ) | |
| alf_filt_coeff_all_zero[altIdx][sfIdx] | u(1) |
| if(!alf_filt_coeff_all_zero[altIdx][sfIdx]) | |
| alf_comp_coeff( ) | |
| if( alf_comp_clip_flag ) | |
| for( sfIdx = 0; sfIdx <= alf_comp_num_filters_signalled_minus1; | |
| sfIdx++ ) | |
| for( j = 0; j < filter_tap_num; j++ ) | |
| alf_comp_clip_idx[altIdx][ sfIdx ][ j ] | u(2) |
| ... | |
| } | |
| } | |
| } | |

The first tap flag bit alf_filt_coeff_all_zero [altIdx] [sfIdx] being 1 indicates that all tap coefficients of an sfIdx^{th} filter in an altIdx^{th} filter bank are 0, and being 0 indicates that not all the tap coefficients of the corresponding filter are 0; and the first tap flag bit is set to 0 by default.

In some embodiments, in the existing design, in a case that the tap coefficient is 0, the corresponding tap coefficient still may be transmitted. In this implementation of this application, in a case that the tap coefficient is 0, the encoding side and the decoding side may agree in advance that a value of a missing tap coefficient is 0. In this case, the tap coefficient whose value is 0 (or the value of the tap coefficient) does not may be transmitted in the video bitstream. During decoding, if the decoding side determines that there is the missing tap coefficient in the filter, it may be determined that the missing tap coefficient is 0.

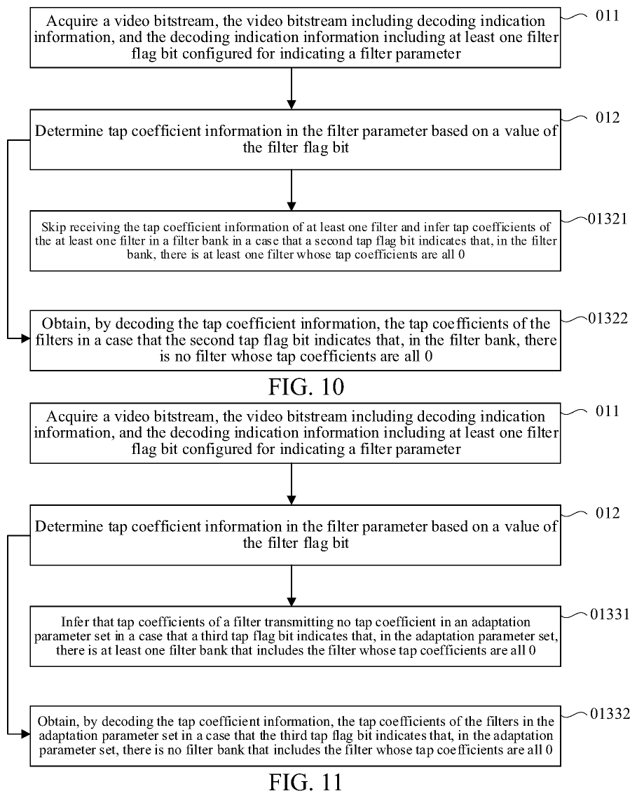

Referring to FIG. 10, in some implementations, the filter flag bit further includes a second tap flag bit, and the second tap flag bit is configured for indicating whether, in a corresponding filter bank, there is at least one filter whose tap coefficients are all 0. In a case that the second tap flag bit is a first preset value, it is determined that the tap coefficient information indicates that, in the filter bank, there is at least one filter whose tap coefficients are all 0. In a case that the second tap flag bit is a second preset value, it is determined that the tap coefficient information indicates that, in the filter bank, there is no filter whose tap coefficients are all 0.

In operation 013, the determining the filter parameter based on the tap coefficient information includes:

Operation 01321: Skip receiving the tap coefficient information of at least one filter and infer tap coefficients of the at least one filter in a filter bank in a case that the second tap flag bit indicates that, in the filter bank, there is at least one filter whose tap coefficients are all 0.

Operation 01322: Obtain, by decoding the tap coefficient information, the tap coefficients of the filters in a case that the second tap flag bit indicates that, in the filter bank, there is no filter whose tap coefficients are all 0.

Specifically, in an adaptation parameter set (APS) of a video bitstream, there is generally one or more filter banks, and each filter bank includes one or more filters. To perform decoding indication for the filter parameter in each filter bank, the filter flag bit may further include the second tap flag bit. The second tap flag bit is configured for indicating whether, in the corresponding filter bank, there is at least one filter whose tap coefficients are all 0.

If the second tap flag bit in the current filter bank is a first preset value, it may be determined that, in the filter bank, there is at least one filter whose tap coefficients are all 0. The second tap flag bit may further indicate the filter whose tap coefficients are all 0 (for example, all the tap coefficients of the sfIdx^{th} filter in the altIdx^{th} filter bank are 0). In this case, the tap coefficients of the sfIdx^{th} filter in the altIdx^{th} filter bank are all redundant data, and the tap coefficient information of the filter may be implicitly transmitted. To be specific, the encoding side does not transmit the tap coefficient information of the filter (i.e., all the tap coefficients of the sfIdx^{th} filter in the altIdx^{th} filter bank), and the decoding side does not receive the tap coefficient information. The decoding side may directly infer that all the tap coefficients of the filter are 0. The first tap flag bit corresponding to the filters in the filter bank is decoded, so that the filter whose tap coefficients are all 0 is determined based on the first tap flag bit. During decoding, if the decoding side decodes that no target filter in the filter bank transmits the tap coefficient, it may be determined that the tap coefficients of the target filter are transmitted implicitly. In this case, it may be inferred that all the tap coefficients of the target filter are 0.

If the second tap flag bit in the current filter bank is the second preset value, it may be determined that, in the filter bank, there is no filter whose tap coefficients are all 0. In this case, the tap coefficients may be explicitly transmitted to the decoding side, and the first tap flag bit corresponding to each filter in the current filter bank does not may be transmitted, thereby reducing transmission of redundant first tap flag bits, and reducing redundant filter flag bits while implementing the decoding indication for the filter parameter with redundant data during transmission. The decoding side decodes the tap coefficient information (i.e., the explicitly transmitted tap coefficients) to obtain the tap coefficients of the filters transmitted in the filter bank.

In one example, a transmission process of a syntax element corresponding to the second tap flag bit is shown in the following Table 3:

| | Descriptor |
|---|---|
| alf_data( ) { | |
| ... | |
| if( alf_comp_filter_signal_flag ) { | |
| ... | |
| alf_comp_num_alt_filters_minus1 | ue(v) |
| for(altIdx = 0; altIdx <= alf_comp_num_alt filters_minus1; altIdx++){ | |
| alf_comp_clip_flag | u(1) |
| alf_comp_num_filters_signalled_minus1 | ue(v) |
| ... | |
| alf_has_filt_coeff_all_zero[altIdx] | u(1) |
| if(alf_has_filt_coef_all_zero[altIdx]) | |
| for( sfIdx = 0; sfIdx <= alf_comp_num_filters_signalled_minus1; | |
| sfIdx++ ) | |
| alf_filt_coeff_all_zero[altIdx][sfIdx] | u(1) |
| for( sfIdx = 0; sfIdx <= alf_comp_num_filters_signalled_minus1; | |
| sfIdx++ ) | |
| if(!alf_filt_coeff_all_zero[altIdx][sfIdx]) | |
| alf_comp_coeff( ) | |
| if( alf_comp_clip_flag ) | |
| for( sfIdx = 0; sfIdx <= alf_comp_num_filters_signalled_minus1; | |
| sfIdx++ ) | |
| for( j = 0; j < filter_tap_num; j++ ) | |
| alf_comp_clip_idx[altIdx][ sfIdx ][ j ] | u(2) |
| ... | |
| } | |
| } | |
| } | |

where the first tap flag bit alf_filt_coeff_all_zero [altIdx] [sfIdx] being 1 indicates that all the tap coefficients of the sfIdx^{th} filter in the altIdx^{th} filter bank are 0, and being 0 indicates that not all the tap coefficients of the corresponding filter are 0; and the first tap flag bit is set to 0 by default.

The second tap flag bit alf_has_filt_coeff_all_zero [altIdx] being 1 indicates that the altIdx^{th} filter bank includes at least one filter whose tap coefficients are all 0, and being 0 indicates that the tap coefficients of all the filters in the filter bank are not all 0.

Referring to FIG. 11, in some implementations, the filters are divided into one or more filter banks, the filter banks are located in an adaptation parameter set, the filter flag bit further includes a third tap flag bit, and the third tap flag bit is configured for indicating whether, in the adaptation parameter set, there is at least one filter bank that includes at least one filter whose tap coefficients are all 0. In a case that the third tap flag bit is a first preset value, it is determined that the tap coefficient information indicates that, in the adaptation parameter set, there is at least one filter bank that includes at least one filter whose tap coefficients are all 0. In a case that the third tap flag bit is a second preset value, it is determined that the tap coefficient information indicates that, in the adaptation parameter set, there is no filter bank that includes the filter whose tap coefficients are all 0.

In operation 013, the determining the filter parameter based on the tap coefficient information includes:

Operation 01331: Skip receiving the tap coefficient information of at least one filter and infer tap coefficients of the at least one filter in at least one filter bank in an adaptation parameter set in a case that the third tap flag bit indicates that, in the adaptation parameter set, there is at least one filter bank that includes at least one filter whose tap coefficients are all 0.

Operation 01332: Obtain, by decoding the tap coefficient information, the tap coefficients of the filters in the adaptation parameter set in a case that the third tap flag bit indicates that, in the adaptation parameter set, there is no filter bank that includes the filter whose tap coefficients are all 0.

Specifically, in the APS of the video bitstream, there is generally one or more filter banks. To indicate whether, in the APS, there is at least one filter bank that includes at least one filter whose tap coefficients are all 0, the filter flag bit further may further include the third tap flag bit. The third tap flag bit is configured for indicating whether, in the adaptation parameter set, there is at least one filter bank that includes at least one filter whose tap coefficients are all 0.

If the third tap flag bit in the APS is the first preset value, it may be determined that, in the APS, there is at least one filter bank that includes at least one filter whose tap coefficients are all 0. The third tap flag bit may further indicate the filter whose tap coefficients are all 0 (for example, all the tap coefficients of the sfIdx^{th} filter in the altIdx^{th} filter bank are 0). In this case, the tap coefficients of the sfIdx^{th} filter in the altIdx^{th} filter bank are all redundant data, and the tap coefficient information of the filter may be implicitly transmitted. To be specific, the encoding side does not transmit the tap coefficient information of the filter (i.e., all the tap coefficients of the sfIdx^{th} filter in the altIdx^{th} filter bank), and the decoding side does not receive the tap coefficient information. The decoding side may directly infer that all the tap coefficients of the filter are 0. The second tap flag bit corresponding to the filter banks in the APS is decoded, to determine the target filter bank including the filter whose tap coefficients are all 0, and then the first tap flag bit corresponding to the filters in the target filter bank is decoded to determine the filter whose tap coefficients are all 0. During decoding, if the decoding side decodes that no target filter in the APS transmits the tap coefficients, it may be determined that the tap coefficients of the target filter are transmitted implicitly. In this case, it may be inferred that the tap coefficients of the target filter are all 0.

If the third tap flag bit in the APS is the second preset value, it may be determined that, in the APS, there is no filter bank that includes the filter whose tap coefficients are all 0. In this case, the tap coefficients of the filters may be explicitly transmitted to the decoding side, and the second tap flag bit corresponding to the filter banks and the first tap flag bit corresponding to each filter do not may be transmitted, thereby reducing transmission of redundant second tap flag bits and first tap flag bits, and reducing redundant filter parameters while implementing decoding indication for the filter parameter with redundant data during transmission. The decoding side decodes the tap coefficient information (i.e., the explicitly-transmitted tap coefficients) to directly obtain the tap coefficients of the filters transmitted in the APS.

In one example, a transmission process of a syntax element corresponding to the third tap flag bit is shown in the following Table 4:

| | Descriptor |
|---|---|
| alf_data( ) { | |
| ... | |
| if( alf_comp_filter_signal flag ) { | |
| ... | |
| alf_comp_num_alt_filters_minus1 | ue(v) |
| alf_alt_has_filt_coeff_all_zero | u(1) |
| for(altIdx = 0; altIdx <= alf_comp_num_alt_filters_minus1; altIdx++){ | |
| alf_comp_clip_flag | u(1) |
| alf_comp_num_filters_signalled_minus1 | ue(v) |
| ... | |
| if(alf_alt has_filt_coeff_all_zero) | |
| alf_has_filt_coeff_all_zero[altIdx] | u(1) |
| if(alf_has_filt_coeff_all_zero[altIdx]) | |
| for( sfIdx = 0; sfIdx <= alf_comp_num_filters_signalled_minus1; | |
| sfIdx++ ) | |
| alf_filt_coeff_all_zero[altIdx][sfIdx] | u(1) |
| for( sfIdx = 0; sfIdx <= alf_comp_num_filters_signalled_minus1; | |
| sfIdx++ ) | |
| if(!alf_filt_coeff_all_zero[altIdx][sfIdx]) | |
| alf_comp_coeff( ) | |
| if( alf_comp_clip_flag ) | |
| for( sfIdx = 0; sfIdx <= alf_comp_num_filters_signalled_minus1; | |
| sfIdx++ ) | |
| for( j = 0; j < filter_tap_num; j++ ) | |
| alf_comp_clip_idx[altIdx][ sfIdx ][ j ] | u(2) |
| ... | |
| } | |
| } | |
| } | |

The third tap flag bit alf_alt_filt_coeff_all_zero being 1 indicates that, in the filter bank supported by the current APS, there is at least one filter whose tap coefficients are all 0, and being 0 indicates that the tap coefficients of all the filters in the filter bank supported by the current APS are not all 0; and the third tap flag bit is set to 0 by default.

The second tap flag bit alf_has_filt_coeff_all_zero [altIdx] being 1 indicates that the altIdx^{th} filter bank includes at least one filter whose tap coefficients are all 0, and being 0 indicates that the tap coefficients of all the filters in the filter bank are not all 0.

The first tap flag bit alf_filt_coeff_all_zero [altIdx] [sfIdx] being 1 indicates that all the tap coefficients of the sfIdx^{th} filter in the altIdx^{th} filter bank are 0, and being 0 indicates that not all the tap coefficients of the corresponding filter are 0; and the first tap flag bit is set to 0 by default.

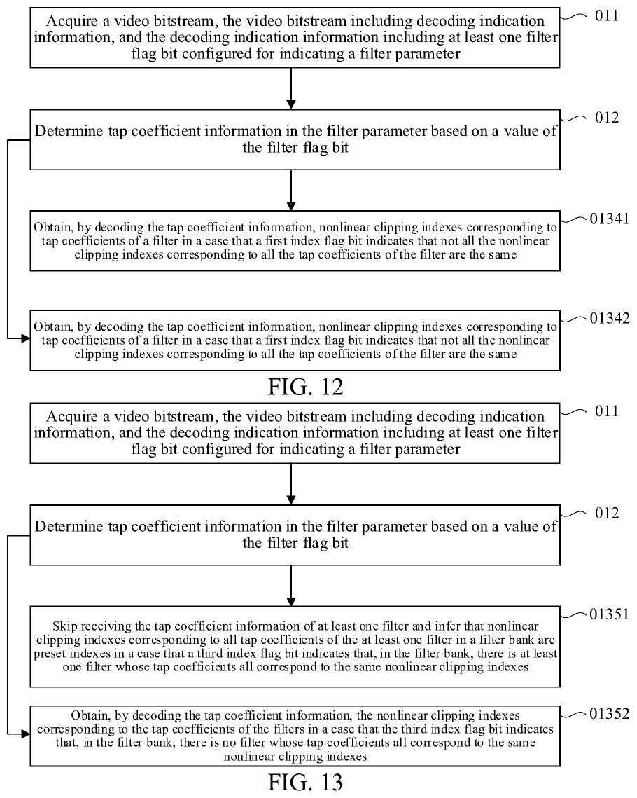

Referring to FIG. 12, in some implementations, the filter flag bit includes a first index flag bit, and the first index flag bit is configured for indicating whether nonlinear clipping indexes corresponding to all tap coefficients of a corresponding filter are the same. In a case that the first index flag bit is a first preset value, it is determined that the tap coefficient information indicates that all the nonlinear clipping indexes corresponding to all the tap coefficients of the filter are the same. In a case that the first index flag bit is a second preset value, it is determined that the tap coefficient information indicates that not all the nonlinear clipping indexes corresponding to all the tap coefficients of the filter are the same.

In operation 013, the determining the filter parameter based on the tap coefficient information includes:

Operation 01341: Obtain, by decoding the tap coefficient information, nonlinear clipping indexes corresponding to tap coefficients of a filter in a case that the first index flag bit indicates that not all the nonlinear clipping indexes corresponding to all the tap coefficients of the filter are the same.

Operation 01342: Obtain, by decoding the tap coefficient information, nonlinear clipping indexes corresponding to tap coefficients of a filter in a case that the first index flag bit indicates that not all the nonlinear clipping indexes corresponding to all the tap coefficients of the filter are the same.

Specifically, in the existing design, in a case that all the nonlinear clipping indexes of one filter are the same, all the nonlinear clipping indexes still may be transmitted for the filter, resulting in abundant redundancy in the transmitted tap coefficients. Therefore, the first index flag bit may be set in the filter flag bit to indicate whether the nonlinear clipping indexes corresponding to all the tap coefficients of the corresponding filter are the same.

In a case that the first index flag bit of the filter that is decoded by the decoding side is the first preset value, it may be determined that all the nonlinear clipping indexes corresponding to all the tap coefficients of the filter are the same. In this case, the nonlinear clipping indexes corresponding to all the tap coefficients of the filter have redundant data during transmission. Therefore, the nonlinear clipping indexes corresponding to all the tap coefficients of the filter may be implicitly transmitted. To be specific, the encoding side does not transmit the tap coefficient information of the filter (i.e., the nonlinear clipping indexes corresponding to all the tap coefficients of the filter), and the decoding side does not receive the tap coefficient information. The decoding side may directly infer the nonlinear clipping indexes corresponding to all the tap coefficients of the filter, such as inferring that all the nonlinear clipping indexes corresponding to all the tap coefficients of the filter are preset indexes (such as the nonlinear clipping index whose value is 0, 1, 2, or 3).

If the first index flag bit of the filter that is decoded by the decoding side is the second preset value, it may be determined that not all the nonlinear clipping indexes corresponding to all the tap coefficients of the filter are the same. In this case, the nonlinear clipping indexes corresponding to the tap coefficients may be explicitly transmitted to the decoding side, and the decoding side decodes the tap coefficient information (i.e., the explicitly-transmitted nonlinear clipping indexes corresponding to all the tap coefficients) to directly obtain the nonlinear clipping indexes corresponding to the tap coefficients transmitted in the filter.

In one example, a transmission process of a syntax element corresponding to the first index flag bit is shown in the following Table 5:

| | Descriptor |
|---|---|
| alf_data( ) { | |
| ... | |
| if( alf_comp_filter_signal_flag ) { | |
| ... | |
| alf_comp_num_alt_filters_minus1 | ue(v) |
| for(altIdx = 0; altIdx <= alf_comp_num_alt_filters_minus1; altIdx++){ | |
| alf_comp_clip_flag | u(1) |
| alf_comp_num_filters_signalled_minus1 | ue(v) |
| ... | |
| for( sfIdx = 0; sfIdx <= alf_comp_num_filters_signalled_minus1; | |
| sfIdx++ ) | |
| alf_comp_coeff( ) | |
| if( alf_comp_clip_flag ) | |
| for( sfIdx = 0; sfIdx <= alf_comp_num_filters_signalled_minus1; | |
| sfIdx++ ) | |
| alf_filt_clip_all_same[altIdx][sfIdx] | u(1) |
| if(!alf_filt_clip_all_same[altIdx][sfIdx]){ | |
| for( j = 0; j < filter_tap_num; j++ ) | |
| alf_comp_clip_idx[altIdx][ sfIdx ][ j ] | u(2) |
| } | |
| ... | |
| } | |
| } | |
| } | |

where the first index flag bit alf_filt_clip_all_same [altIdx] [sfIdx] being 1 indicates that all the tap coefficients of the sfIdx^{th} filter in the altIdx^{th} filter bank use the same nonlinear clipping indexes, and being 0 indicates that not all the nonlinear clipping indexes of the corresponding filter are the same; and the first index flag bit is set to 0 by default.

In some embodiments, the filter flag bit further includes a second index flag bit, and the second index flag bit is configured for indicating the nonlinear clipping index shared by all the tap coefficients of the corresponding filter.

In a case that the first index flag bit of the filter that is decoded by the decoding side is the first preset value, it may be determined that all the nonlinear clipping indexes corresponding to all the tap coefficients of the filter are the same. In this case, the nonlinear clipping indexes corresponding to all the tap coefficients of the filter have redundant data during transmission. Therefore, the nonlinear clipping indexes corresponding to all the tap coefficients of the filter may be implicitly transmitted. The decoding side may directly determine that the nonlinear clipping indexes corresponding to all the tap coefficients of the filter are equal to a value of the second index flag bit, such as the nonlinear clipping indexes that are the second index flag bit whose value is 0, 1, 2, or 3. The nonlinear clipping indexes corresponding to the second index flag bit are the same as the nonlinear clipping indexes corresponding to all the tap coefficients of the filter.

In this way, by introducing the second index flag bit indicating the nonlinear clipping indexes corresponding to all the tap coefficients of the filter, the decoding indication accuracy is higher than that achieved by determining, as the preset index, the nonlinear clipping index of the filter in which all tap coefficients correspond to the same nonlinear clipping index.

In one example, a transmission process of syntax elements corresponding to the first index flag bit and the second index flag bit is shown in the following Table 6:

| | Descriptor |
|---|---|
| alf_data( ) { | |
| ... | |
| if( alf_comp_filter_signal_flag ) { | |
| ... | |
| alf_comp_num_alt_filters_minus1 | ue(v) |
| for(altIdx = 0; altIdx <= alf_comp_num_alt_filters_minus1; altIdx++){ | |
| alf_comp_clip_flag | u(1) |
| alf_comp_num_filters_signalled_minus1 | ue(v) |
| ... | |
| for( sfIdx = 0; sfIdx <= alf_comp_num_filters_signalled_minus1; | |
| sfIdx++ ) | |
| alf_comp_coeff( ) | |
| if( alf_comp_clip_flag ) | |
| for( sfIdx = 0; sfIdx <= | |
| alf_comp_num_filters_signalled_minus1; sfIdx++ ) | |
| alf_filt_clip_all_same[altIdx][sfIdx] | u(1) |
| if(alf_filt_clip_all_same[altIdx][sfIdx]) | |
| alf_filt_same_clip_index[altIfx][sfIdx] | u(2) |
| else{ | |
| for( j = 0; j < filter_tap_num; j++ ) | |
| alf_comp_clip_idx[altIdx][ sfIdx ][ j ] | u(2) |
| } | |
| ... | |
| } | |
| } | |
| } | |

where the first index flag bit alf_filt_clip_all_same [altIdx] [sfIdx] being 1 indicates that all the tap coefficients of the sfIdx^{th} filter in the altIdx^{th} filter bank use the same nonlinear clipping indexes, and being 0 indicates that not all the nonlinear clipping indexes of the corresponding filter are the same; and the first index flag bit is set to 0 by default.

The second index flag bit alf_filt_same_clip_index [altIfx] [sfIdx] indicates the nonlinear clipping index used by all the tap coefficients of the sfIdx^{th} filter in the altIdx^{th} filter bank.

In some embodiments, in the existing design, in a case that the tap coefficient is 0, the nonlinear clipping index corresponding to the tap coefficient still may be transmitted. In this implementation of this application, in a case that the tap coefficient is 0, the encoding side and the decoding side may agree in advance that the nonlinear clipping index corresponding to the tap coefficient whose value is 0 is a preset index. In this case, the nonlinear clipping index corresponding to the tap coefficient whose value is 0 does not may be transmitted in the video bitstream. During decoding, the decoding side may determine the nonlinear clipping index corresponding to the tap coefficient whose value is 0 as the preset index.

Referring to FIG. 13, in some implementations, the filters are divided into one or more filter banks, the filter flag bit further includes a third index flag bit, and the third index flag bit is configured for indicating whether, in the corresponding filter bank, there is at least one filter whose tap coefficients all correspond to the same nonlinear clipping indexes. In a case that the third index flag bit is a first preset value, it is determined that the tap coefficient information indicates that, in the filter bank, there is at least one filter whose tap coefficients all correspond to the same nonlinear clipping indexes. In a case that the third index flag bit is a second preset value, it is determined that the tap coefficient information indicates that, in the filter bank, there is no filter whose tap coefficients all correspond to the same nonlinear clipping indexes.

In operation 013, the determining the filter parameter based on the tap coefficient information includes:

Operation 01351: Skip receiving the tap coefficient information of at least one filter and infer that nonlinear clipping indexes corresponding to all tap coefficients of the at least one filter in a filter bank are preset indexes in a case that the third index flag bit indicates that, in the filter bank, there is at least one filter whose tap coefficients all correspond to the same nonlinear clipping indexes.

Operation 01352: Obtain, by decoding the tap coefficient information, the nonlinear clipping indexes corresponding to the tap coefficients of the filters in a case that the third index flag bit indicates that, in the filter bank, there is no filter whose tap coefficients all correspond to the same nonlinear clipping indexes.

Specifically, in the APS of the video bitstream, there is generally one or more filter banks. To perform decoding indication for the filter parameter with redundant data during transmission in each filter bank, the filter flag bit may further include the third index flag bit. The third index flag bit is configured for indicating whether, in the filter bank, there is at least one filter whose tap coefficients all correspond to the same nonlinear clipping indexes.

If the third index flag bit in the current filter bank is the first preset value, it may be determined that, in the filter bank, there is at least one filter whose tap coefficients all correspond to the same nonlinear clipping indexes. The third index flag bit may further indicate the filter whose tap coefficients all correspond to the same nonlinear clipping indexes (for example, all the nonlinear clipping indexes corresponding to the tap coefficients of the sfIdx^{th} filter in the altIdx^{th} filter bank are the same). In this case, the tap coefficients of the sfIdx^{th} filter in the altIdx^{th} filter bank are all redundant data, and the tap coefficient information of the filter may be implicitly transmitted. To be specific, the encoding side does not transmit the tap coefficient information of the filter (i.e., all the tap coefficients of the sfIdx^{th} filter in the altIdx^{th} filter bank), and the decoding side does not receive the tap coefficient information. The decoding side may directly infer the nonlinear clipping indexes corresponding to all the tap coefficients of the filter, such as inferring that all the nonlinear clipping indexes corresponding to all the tap coefficients are preset indexes (such as the nonlinear clipping index whose value is 0, 1, 2, or 3). The first index flag bit corresponding to each filter in the filter bank is decoded, so that the filter whose tap coefficients all correspond to the same nonlinear clipping indexes is determined based on the first index flag bit. During decoding, if the decoding side decodes that no target filter in the filter bank transmits the nonlinear clipping indexes corresponding to the tap coefficients, it may be determined that the nonlinear clipping indexes corresponding to the tap coefficients of the target filter are transmitted implicitly. In this case, it may be inferred that the nonlinear clipping indexes corresponding to the tap coefficients of the target filter are all preset indexes.

If the third index flag bit in the current filter bank is the second preset value, it may be determined that, in the filter bank, there is no filter whose tap coefficients all correspond to the same nonlinear clipping indexes. In this case, the nonlinear clipping indexes corresponding to the tap coefficients may be explicitly transmitted to the decoding side, and the first index flag bit corresponding to each filter in the current filter bank does not may be transmitted, thereby reducing transmission of the redundant first index flag bit, and reducing redundant filter flag bits while implementing the decoding indication for the filter parameter with redundant data during transmission. The decoding side decodes the tap coefficient information (i.e., the explicitly-transmitted nonlinear clipping indexes corresponding to all the tap coefficients) to directly obtain the nonlinear clipping indexes corresponding to the tap coefficients of the filters transmitted in the filter bank.

In one example, a transmission process of a syntax element corresponding to the third index flag bit is shown in the following Table 7:

| | Descriptor |
|---|---|
| alf_data( ) { | |
| ... | |
| if( alf_comp_filter_signal_flag ) { | |
| ... | |
| alf_comp_num_alt_filters_minus1 | ue(v) |
| for(altIdx = 0; altIdx <= alf_comp_num_alt_filters_minus1; altIdx++){ | |
| alf_comp_clip_flag | u(1) |
| alf_comp_num_filters_signalled_minus1 | ue(v) |
| ... | |
| if(alf_comp_clip_flag){ | |
| alf_has_filt_clip_all_same[altIdx] | u(1) |
| if(alf_has_filt_clip_all_same[altIdx]){ | |
| for( sfIdx = 0; sfIdx <= | |
| alf_comp_num_filters_signalled_minus1; sfIdx++ ) | |
| alf_filt_clip_all_same[altIdx][sfIdx] | u(1) |
| } | |
| } | |
| for( sfIdx = 0; sfIdx <= alf_comp_num_filters_signalled_minus1; | |
| sfIdx++ ) | |
| alf_comp_coeff( ) | |
| if( alf_comp_clip_flag ) | |
| for( sfIdx = 0; sfIdx <= alf_comp_num_filters_signalled_minus1; | |
| sfIdx++ ) | |
| if(alf_filt_clip_all_same[altIdx][sfIdx]) | |
| alf_filt_same_clip_index[altIdx][sfIdx] | u(2) |
| else | |
| for( j = 0; j < filter_tap_num; j++ ) | |
| alf_comp_clip_idx[altIdx][ sfIdx ][ j ] | u(2) |
| ... | |
| } | |
| } | |
| } | |

where the third index flag bit alf_has_filt_clip_all_same [altIdx] being 1 indicates that the altIdx^{th} filter bank includes at least one filter whose tap coefficients all correspond to the same nonlinear clipping indexes. The third index flag bit being 0 indicates that the altIdx^{th} filter bank includes no filter whose tap coefficients use the same nonlinear clipping indexes. The third index flag bit is set to 0 by default.

The first index flag bit alf_filt_clip_all_same [altIdx] [sfIdx] being 1 indicates that all the nonlinear clipping indexes corresponding to the tap coefficients of the sfIdx^{th} filter in the altIdx^{th} filter bank are the same, and being 0 indicates that not all the nonlinear clipping indexes corresponding to the tap coefficients of the corresponding filter are the same. The first index flag bit is set to 0 by default.

The second index flag bit alf_filt_same_clip_index [altIdx] [sfIdx] indicates the nonlinear clipping index shared by the tap coefficients of the sfIdx^{th} filter in the altIdx^{th} filter bank.

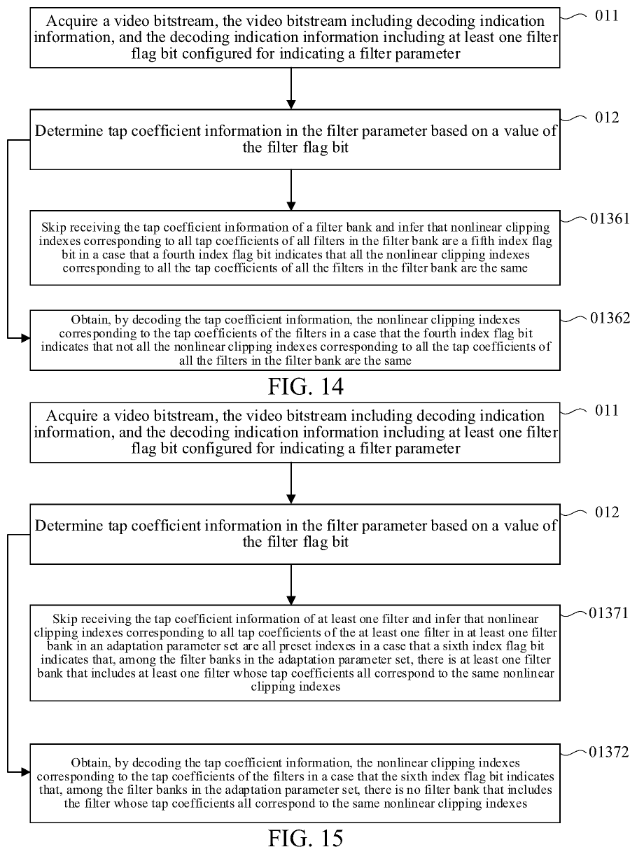

Referring to FIG. 14, in some implementations, filters are divided into one or more filter banks, the filter flag bit further includes a fourth index flag bit, and the fourth index flag bit is configured for indicating whether all nonlinear clipping indexes corresponding to all tap coefficients of all filters in a corresponding filter bank are the same. In a case that the fourth index flag bit is a first preset value, it is determined that the tap coefficient information indicates that all the nonlinear clipping indexes corresponding to all the tap coefficients of all the filters in the filter bank are the same. In a case that the fourth index flag bit is a second preset value, it is determined that the tap coefficient information indicates that not all the nonlinear clipping indexes corresponding to all the tap coefficients of all the filters in the filter bank are the same.

In operation 013, the determining the filter parameter based on the tap coefficient information includes:

Operation 01361: Skip receiving the tap coefficient information of the filter bank and infer that nonlinear clipping indexes corresponding to all tap coefficients of all the filters in a filter bank are a fifth index flag bit in a case that the fourth index flag bit indicates that all the nonlinear clipping indexes corresponding to all the tap coefficients of all the filters in the filter bank are the same.

Operation 01362: Obtain, by decoding the tap coefficient information, the nonlinear clipping indexes corresponding to the tap coefficients of the filters in a case that the fourth index flag bit indicates that not all the nonlinear clipping indexes corresponding to all the tap coefficients of all the filters in the filter bank are the same.

Specifically, in the existing design, when all the nonlinear clipping indexes corresponding to all the tap coefficients in the filter bank are the same, the nonlinear clipping indexes corresponding to the filter bank still may be transmitted. In this implementation of this application, in a case that all the nonlinear clipping indexes corresponding to all the tap coefficients in the filter bank are the same, the encoding side and the decoding side may agree in advance that the nonlinear clipping indexes of the filter bank whose tap coefficients all correspond to the same nonlinear clipping indexes are preset indexes. In this case, the nonlinear clipping indexes of the filter bank whose tap coefficients all correspond to the same nonlinear clipping indexes may not may be transmitted in the video bitstream.

If the fourth index flag bit in the current filter bank is the first preset value, it may be determined that the nonlinear clipping indexes corresponding to all the tap coefficients of all filters in the filter bank are all filter parameters with redundant data during transmission. Therefore, the nonlinear clipping indexes corresponding to all the tap coefficients in the filter bank may be implicitly transmitted. To be specific, the encoding side does not transmit the tap coefficient information of the filter bank (i.e., the nonlinear clipping indexes corresponding to all the tap coefficients of the filter bank), and the decoding side does not receive the tap coefficient information of the filter bank, thereby inferring that all the nonlinear clipping indexes corresponding to all the tap coefficients of all the filters in the filter bank are preset indexes.

If the fourth index flag bit of the current filter bank is the second preset value, it may be determined that not all the nonlinear clipping indexes corresponding to all the tap coefficients of all the filters in the filter bank are the same. In this case, the nonlinear clipping indexes corresponding to the tap coefficients may be explicitly transmitted to the decoding side, and the decoding side decodes the tap coefficient information (i.e., the explicitly-transmitted nonlinear clipping indexes corresponding to all the tap coefficients) to directly obtain the nonlinear clipping indexes corresponding to the tap coefficients transmitted in the filter bank. The decoding side may decode the third index flag bit to determine whether, in the filter bank, there is at least one filter whose tap coefficients all correspond to the same nonlinear clipping indexes, thereby determining the filter bank whose third index flag bit is the first preset value. Then the decoding side may decode the first index flag bit corresponding to each filter in the filter bank whose third index flag bit is the first preset value to determine the filter whose first index flag bit is the first preset value. In this way, the nonlinear clipping indexes corresponding to the tap coefficients of the filters in the filter bank are obtained based on the tap coefficient information obtained by decoding the index flag bits.

In some embodiments, the filter flag bit further includes a fifth index flag bit, and the fifth index flag bit is configured for indicating the nonlinear clipping index shared by all tap coefficients of a corresponding filter bank.

In a case that the fourth index flag bit of the filter bank that is decoded by the decoding side is the first preset value, it may be determined that the nonlinear clipping indexes corresponding to all the tap coefficients of all the filters in the filter bank are all filter parameters with redundant data during transmission, thereby inferring that all the nonlinear clipping indexes corresponding to all the tap coefficients of all the filters in the filter bank are the fifth index flag bit, such as the nonlinear clipping indexes corresponding to the fifth index flag bit whose value is 0, 1, 2, or 3. The nonlinear clipping indexes corresponding to the fifth index flag bit are the same as the nonlinear clipping indexes corresponding to all the tap coefficients of the filter bank.

In this way, by introducing the fifth index flag bit indicating the nonlinear clipping indexes corresponding to all the tap coefficients of the filter bank, the decoding indication accuracy is higher than that achieved by determining, as the preset index, the nonlinear clipping index of the filter bank in which all tap coefficients correspond to the same nonlinear clipping index.

In one example, a transmission process of syntax elements corresponding to the fourth index flag bit and the fifth index flag bit is shown in the following Table 8:

| | Descriptor |
|---|---|
| alf_data( ) { | |
| ... | |
| if( alf_comp_filter_signal_flag ) { | |
| ... | |
| alf_comp_num_alt_filters_minus1 | ue(v) |
| for(altIdx = 0; altIdx <= alf_comp_num_alt_filters_minus1; altIdx++){ | |
| alf_comp_clip_flag | u(1) |
| alf_comp_num_filters_signalled_minus1 | ue(v) |
| ... | |
| if(alf_comp_clip_flag){ | |
| alf_filtset_all_filt_clip_same[altIdx] | u(1) |
| if(alf_filtset_all_filt_clip_same[altIdx]) | |
| alf_filtset_all_filt_clip_index[altIdx] | u(2) |
| else | |
| alf_has_filt_clip_all_same[altIdx] | u(1) |
| if(alf_has_filt_clip_all_same[altIdx]){ | |
| for( sfIdx = 0; sfIdx <= | |
| alf_comp_num_filters_signalled_minus1; sfIdx++ ) | |
| alf_filt_clip_all_same[altIdx][sfIdx] | u(1) |
| } | |
| } | |
| for( sfIdx = 0; sfIdx <= alf_comp_num_filters_signalled_minus1; | |
| sfIdx++ ) | |
| alf_comp_coeff( ) | |
| if( alf_comp_clip_flag && !alf_filtset_all_filt_clip_same[altIdx]) | |
| for( sfIdx = 0; sfIdx <= alf_comp_num_filters_signalled_minus1; | |
| sfIdx++ ) | |
| if(alf_filt_clip_all_same[altIdx][sfIdx]) | |
| alf_filt_same_clip_index[altIdx][sfIdx] | u(2) |
| else | |
| for( j = 0; j < filter_tap_num; j++ ) | |
| alf_comp_clip_idx[altIdx][ sfIdx ][ j ] | u(2) |
| ... | |
| } | |
| } | |
| } | |

where the fourth index flag bit alf_filtset_all_filt_clip_same [altIdx] being 1 indicates that the tap coefficients of all the filters in the altIdx^{th} filter bank use the same nonlinear clipping indexes, and being 0 indicates that not all the tap coefficients of all the filters in the corresponding filter bank use the same nonlinear clipping indexes. The fourth index flag bit is set to 0 by default.

The fifth index flag bit alf_filtset_all_filt_clip_index [altIdx] indicates the same nonlinear clipping index used by all the filters in the altIdx^{th} filter bank.

The third index flag bit alf_has_filt_clip_all_same [altIdx] being 1 indicates that the altIdx^{th} filter bank includes at least one filter whose tap coefficients all correspond to the same nonlinear clipping indexes. The third index flag bit being 0 indicates that the altIdx^{th} filter bank includes no filter whose tap coefficients use the same nonlinear clipping indexes. The third index flag bit is set to 0 by default.

The first index flag bit alf_filt_clip_all_same [altIdx] [sfIdx] being 1 indicates that all the nonlinear clipping indexes corresponding to the tap coefficients of the sfIdx^{th} filter in the altIdx^{th} filter bank are the same, and being 0 indicates that not all the nonlinear clipping indexes corresponding to the tap coefficients of the corresponding filter are the same. The first index flag bit is set to 0 by default.

The second index flag bit alf_filt_same_clip_index [altIdx] [sfIdx] indicates the nonlinear clipping index shared by the tap coefficients of the sfIdx^{th} filter in the altIdx^{th} filter bank.

Referring to FIG. 15, in some implementations, the filters are divided into one or more filter banks, the filter banks are located in an adaptation parameter set, the filter flag bit further includes a sixth index flag bit, and the sixth index flag bit indicates whether, among the filter banks in the adaptation parameter set, there is at least one filter bank that includes at least one filter whose tap coefficients all correspond to the same nonlinear clipping indexes. In a case that the sixth index flag bit is a first preset value, the tap coefficient information indicates that, among the filter banks in the adaptation parameter set, there is at least one filter bank that includes at least one filter whose tap coefficients all correspond to the same nonlinear clipping indexes. In a case that the sixth index flag bit is a second preset value, the tap coefficient information indicates that, among the filter banks in the adaptation parameter set, there is no filter bank that includes the filter whose tap coefficients all correspond to the same nonlinear clipping indexes.

In operation 013, the determining the filter parameter based on the tap coefficient information includes:

Operation 01371: Skip receiving the tap coefficient information of at least one filter and infer that the nonlinear clipping indexes corresponding to all tap coefficients of at least one filter in at least one filter bank in the adaptation parameter set are all preset indexes in a case that the sixth index flag bit indicates that, among the filter banks in the adaptation parameter set, there is at least one filter bank that includes at least one filter whose tap coefficients all correspond to the same nonlinear clipping indexes.

Operation 01372: Obtain, by decoding the tap coefficient information, the nonlinear clipping indexes corresponding to the tap coefficients of the filters in a case that the sixth index flag bit indicates that, among the filter banks in the adaptation parameter set, there is no filter bank that includes the filter whose tap coefficients all correspond to the same nonlinear clipping indexes.

Specifically, in the APS of the video bitstream, there is generally one or more filter banks. To indicate whether, in the APS, there is at least one filter bank that includes the filter whose tap coefficients all correspond to the same nonlinear clipping indexes. The filter flag bit further includes the sixth index flag bit. The sixth index flag bit is configured for indicating whether, in the adaptation parameter set, there is at least one filter bank that includes the filter whose tap coefficients all correspond to the same nonlinear clipping indexes.

If the sixth index flag bit in the APS is a first preset value, it may be determined that, in the APS, there is at least one filter bank that includes at least one filter whose tap coefficients all correspond to the same nonlinear clipping indexes. The sixth index flag bit may indicate the filter whose tap coefficients all correspond to the same nonlinear clipping indexes (for example, all the nonlinear clipping indexes corresponding to the tap coefficients of the sfIdx^{th} filter in the altIdx^{th} filter bank are the same). In this case, the tap coefficients of the sfIdx^{th} filter in the altIdx^{th} filter bank are all redundant data, and the tap coefficient information of the filter may be implicitly transmitted. To be specific, the encoding side does not transmit the tap coefficient information of the filter (i.e., all the tap coefficients of the sfIdx^{th} filter in the altIdx^{th} filter bank), and the decoding side does not receive the tap coefficient information. The decoding side may directly infer the nonlinear clipping indexes corresponding to all the tap coefficients of the filter, such as inferring that the nonlinear clipping indexes corresponding to all the tap coefficients are all preset indexes (such as the nonlinear clipping index whose value is 0, 1, 2, or 3). The fourth index flag bit corresponding to each filter bank in the APS is decoded to determine a first target filter bank whose tap coefficients all correspond to the same nonlinear clipping indexes. If there is no first target filter bank whose tap coefficients all correspond to the same nonlinear clipping indexes, the third index flag bit corresponding to each filter bank is decoded to determine a second target filter bank that includes the filter whose tap coefficients all correspond to the same nonlinear clipping indexes; and then the first index flag bit corresponding to each filter in the second target filter bank is decoded to determine the filter whose tap coefficients all correspond to the same nonlinear clipping indexes, thereby inferring that the nonlinear clipping indexes of the filter whose tap coefficients all correspond to the same nonlinear clipping indexes are preset indexes. When the sixth index flag bit in the APS is the first preset value, the third index flag bit corresponding to each filter bank is directly decoded, to determine the second target filter bank that includes the filter whose tap coefficients all correspond to the same nonlinear clipping indexes; and then the first index flag bit corresponding to each filter in the second target filter bank is decoded, to determine the filter whose tap coefficients all correspond to the same nonlinear clipping indexes. During decoding, if the decoding side decodes that no target filter in the filter bank transmits the nonlinear clipping indexes corresponding to the tap coefficients, it may be determined that the nonlinear clipping indexes corresponding to the tap coefficients of the target filter are transmitted implicitly. In this case, it may be inferred that the nonlinear clipping indexes corresponding to the tap coefficients of the target filter are all preset indexes.

If the sixth index flag bit in the APS is the second preset value, it may be determined that, in the APS, there is no filter bank that includes the filter whose tap coefficients all correspond to the same nonlinear clipping indexes. In this case, the nonlinear clipping indexes corresponding to the tap coefficients of each filter in the APS may be explicitly transmitted to the decoding side, and the third index flag bit and the fourth index flag bit that correspond to each filter bank and the first index flag bit and the second index flag bit that correspond to each filter do not may be transmitted, thereby reducing transmission of redundant first index flag bits to fourth index flag bits, and reducing redundant filter flag bits while implementing decoding indication for the filter parameter with redundant data during transmission. The decoding side decodes the tap coefficient information (i.e., the explicitly-transmitted nonlinear clipping indexes corresponding to all the tap coefficients) to directly decode the nonlinear clipping indexes corresponding to the tap coefficients of the filters transmitted in the filter bank.

In one example, a transmission process of a syntax element corresponding to the sixth index flag bit is shown in the following Table 9:

| | Descriptor |
|---|---|
| alf_data( ) { | |
| ... | |
| if( alf_comp_filter_signal_flag ) { | |
| ... | |
| alf_comp_num_alt_filters_minus1 | ue(v) |
| alf_alt_has_filt_clip_all_same | u(1) |
| for(altIdx = 0; altIdx <= alf_comp_num_alt_filters_minus1; altIdx++){ | |
| alf_comp_clip_flag | u(1) |
| alf_comp_num_filters_signalled_minus1 | ue(v) |
| ... | |
| if(alf_alt_has_filt_clip_all_same && alf_comp_clip_flag) | |
| alf_has_filt_clip_all_same[altIdx] | u(1) |
| if(alf_has_filt_clip_all_same[altIdx]){ | |
| for( sfIdx = 0; sfIdx <= alf_comp_num_filters_signalled_minus1; | |
| sfIdx++ ) | |
| alf_filt_clip_all_same[altIdx][sfIdx] | u(1) |
| } | |
| for( sfIdx = 0; sfIdx <= alf_comp_num_filters_signalled_minus1; | |
| sfIdx++ ) | |
| alf_comp_coeff( ) | |
| if( alf_comp_clip_flag ) | |
| for( sfIdx = 0; sfIdx <= alf_comp_num_filters_signalled_minus1; | |
| sfIdx++ ) | |
| if(alf_filt_clip_all_same[altIdx][sfIdx]) | |
| alf_filt same_clip_index[altIdx][sfIdx] | u(2) |
| else | |
| for( j = 0; j < filter_tap_num; j++ ) | |
| alf_comp_clip_idx[altIdx][ sfIdx ][ j ] | u(2) |
| ... | |
| } | |
| } | |
| } | |

where the sixth index flag bit alf_alt_has_filt_clip_all_same being 1 indicates that, among the filter banks supported by the current APS, there is at least one filter bank that includes the filter using the same nonlinear clipping indexes. The sixth index flag bit being 0 indicates that none of the filters included in the filter banks supported by the current APS use the same nonlinear clipping indexes. The sixth index flag bit is set to 0 by default.

The third index flag bit alf_has_filt_clip_all_same [altIdx] being 1 indicates that the altIdx^{th} filter bank includes at least one filter whose tap coefficients all use the same nonlinear clipping indexes. The third index flag bit being 0 indicates that the altIdx^{th} filter bank includes no filter whose tap coefficients use the same nonlinear clipping indexes. The third index flag bit is set to 0 by default.

The first index flag bit alf_filt_clip_all_same [altIdx] [sfIdx] being 1 indicates that all the nonlinear clipping indexes corresponding to the tap coefficients of the sfIdx^{th} filter in the altIdx^{th} filter bank are the same, and being 0 indicates that not all the nonlinear clipping indexes corresponding to the tap coefficients of the corresponding filter are the same. The first index flag bit is set to 0 by default.

The second index flag bit alf_filt_same_clip_index [altIdx] [sfIdx] indicates the nonlinear clipping index shared by the tap coefficients of the sfIdx^{th} filter in the altIdx^{th} filter bank.

In another example, a transmission process of a syntax element corresponding to the sixth index flag bit is shown in the following Table 10:

| | Descriptor |
|---|---|
| alf_data( ) { | |
| ... | |
| if( alf_comp_filter_signal_flag ) { | |
| ... | |
| alf_comp_num_alt_filters_minus1 | ue(v) |
| alf_alt_has_filt_clip_all_same | u(1) |
| for(altIdx = 0; altIdx <= alf_comp_num_alt_filters_minus1; altIdx++){ | |
| alf_comp_clip_flag | u(1) |
| alf_comp_num_filters_signalled_minus1 | ue(v) |
| ... | |
| if(alf_alt_has_filt_clip_all_same && alf_comp_clip_flag){ | |
| alf_filtset_all_filt_clip_same[altIdx] | u(1) |
| if(alf_filtset_all_filt_clip_same[altIdx]) | |
| alf_filtset_all_filt_clip_index[altIdx] | u(2) |
| else | |
| alf_has_filt_clip_all_same[altIdx] | u(1) |
| if(alf_has_filt_clip_all_same[altIdx]){ | |
| for( sfIdx = 0; sfIdx <= | |
| alf_comp_num_filters_signalled_minus1; sfIdx++ ) | |
| alf_filt_clip_all_same[altIdx][sfIdx] | u(1) |
| } | |
| } | |
| for( sfIdx = 0; sfIdx <= alf_comp_num_filters_signalled_minus1; | |
| sfIdx++ ) | |
| alf_comp_coeff( ) | |
| if( alf_comp_clip_flag && !alf_filtset_all_filt_clip_same[altIdx]) | |
| for( sfIdx = 0; sfIdx <= alf_comp_num_filters_signalled_minus1; | |
| sfIdx++ ) | |
| if(alf_filt_clip_all_same[altIdx][sfIdx]) | |
| alf_filt_same_clip_index[altIdx][sfIdx] | u(2) |
| else | |
| for( j = 0; j < filter_tap_num; j++ ) | |
| alf_comp_clip_idx[altIdx][ sfIdx ][ j ] | u(2) |
| ... | |
| } | |
| } | |
| } | |

where the sixth index flag bit alf_alt_has_filt_clip_all_same being 1 indicates that, among the filter banks supported by the current APS, there is at least one filter bank that includes the filter using the same nonlinear clipping indexes. The sixth index flag bit being 0 indicates that none of the filters included in the filter banks supported by the current APS use the same nonlinear clipping indexes. The sixth index flag bit is set to 0 by default.

The fourth index flag bit alf_filtset_all_filt_clip_same [altIdx] being 1 indicates that the tap coefficients of all the filters in the altIdx^{th} filter bank use the same nonlinear clipping indexes, and being 0 indicates that not all the tap coefficients of all the filters in the corresponding filter bank use the same nonlinear clipping indexes. The fourth index flag bit is set to 0 by default.

The fifth index flag bit alf_filtset_all_filt_clip_index [altIdx] indicates the same nonlinear clipping index used by all the filters in the altIdx^{th} filter bank.

The third index flag bit alf_has_filt_clip_all_same [altIdx] being 1 indicates that the altIdx^{th} filter bank includes at least one filter whose tap coefficients all use the same nonlinear clipping indexes. The third index flag bit being 0 indicates that the altIdx^{th} filter bank includes no filter whose tap coefficients use the same nonlinear clipping indexes. The third index flag bit is set to 0 by default.

The first index flag bit alf_filt_clip_all_same [altIdx] [sfIdx] being 1 indicates that all the nonlinear clipping indexes corresponding to the tap coefficients of the sfIdx^{th} filter in the altIdx^{th} filter bank are the same, and being 0 indicates that not all the nonlinear clipping indexes corresponding to the tap coefficients of the corresponding filter are the same. The first index flag bit is set to 0 by default.

The second index flag bit alf_filt_same_clip_index [altIdx] [sfIdx] indicates the nonlinear clipping index shared by the tap coefficients of the sfIdx^{th} filter in the altIdx^{th} filter bank.

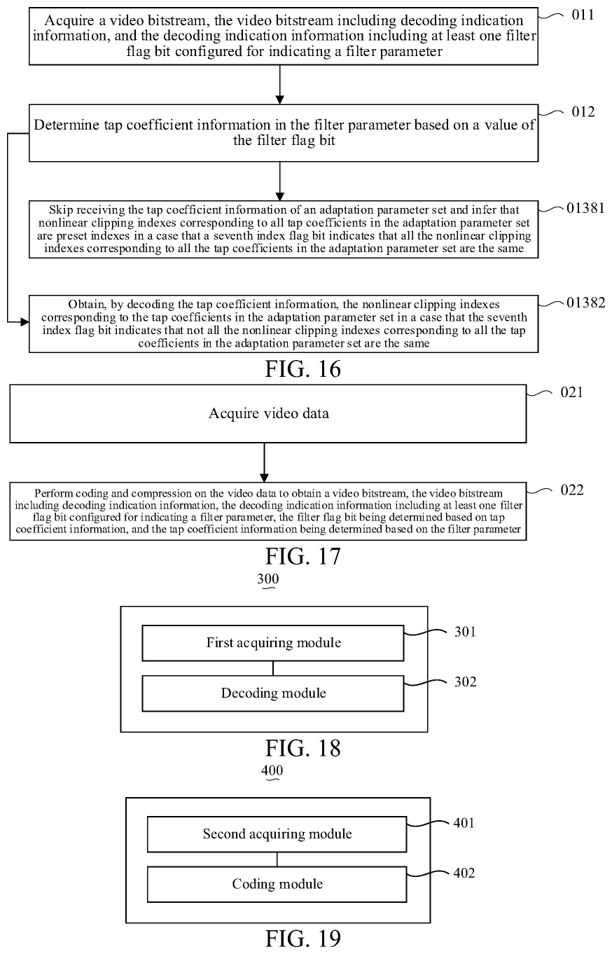

Referring to FIG. 16, in some implementations, the filter flag bit further includes a seventh index flag bit, and the seventh index flag bit is configured for indicating that all nonlinear clipping indexes corresponding to all tap coefficients of all filters in all filter banks in the adaptation parameter set are the same. In a case that the seventh index flag bit is a first preset value, it is determined that the tap coefficient information indicates that all the nonlinear clipping indexes corresponding to all tap coefficients in the adaptation parameter set are the same. In a case that the seventh index flag bit is a second preset value, it is determined that the tap coefficient information indicates that not all the nonlinear clipping indexes corresponding to all the tap coefficients in the adaptation parameter set are the same. The first preset value is different from the second preset value.

In operation 013, the determining the filter parameter based on the tap coefficient information includes:

Operation 01381: Skip receiving the tap coefficient information of an adaptation parameter set and infer that nonlinear clipping indexes corresponding to all tap coefficients in the adaptation parameter set are preset indexes in a case that the seventh index flag bit indicates that all the nonlinear clipping indexes corresponding to all the tap coefficients in the adaptation parameter set are the same.

Operation 01382: Obtain, by decoding the tap coefficient information, the nonlinear clipping indexes corresponding to the tap coefficients in the adaptation parameter set in a case that the seventh index flag bit indicates that not all the nonlinear clipping indexes corresponding to all the tap coefficients in the adaptation parameter set are the same.

Specifically, in the existing design, when all the nonlinear clipping indexes corresponding to all the tap coefficients of all the filters in the adaptation parameter set are the same, the nonlinear clipping indexes corresponding to the adaptation parameter set still may be transmitted. In this implementation of this application, in a case that all the nonlinear clipping indexes corresponding to all the tap coefficients in the adaptation parameter set are the same, the encoding side and the decoding side may agree in advance that the nonlinear clipping indexes of the adaptation parameter set whose tap coefficients all correspond to the same nonlinear clipping indexes are preset indexes. In this case, the nonlinear clipping indexes of the adaptation parameter set whose tap coefficients all correspond to the same nonlinear clipping indexes may not may be transmitted in the video bitstream.

If the seventh index flag bit of a current filter bank is a first preset value, it may be determined that the nonlinear clipping indexes corresponding to all the tap coefficients in the adaptation parameter set are all filter parameters with redundant data during transmission. In this case, all the nonlinear clipping indexes in the adaptation parameter set are implicitly transmitted. To be specific, the encoding side does not transmit the tap coefficient information of the adaptation parameter set (i.e., the nonlinear clipping indexes corresponding to all the tap coefficients of the adaptation parameter set), and the decoding side does not receive the tap coefficient information of the adaptation parameter set, thereby inferring that the nonlinear clipping indexes corresponding to all the tap coefficients of the adaptation parameter set are preset indexes.

If the seventh index flag bit of the current filter bank is a second preset value, it may be determined that not all the nonlinear clipping indexes corresponding to all the tap coefficients of the adaptation parameter set are the same. In this case, the nonlinear clipping indexes corresponding to the tap coefficients may be explicitly transmitted to the decoding side, and the decoding side decodes the tap coefficient information (i.e., the explicitly-transmitted nonlinear clipping indexes corresponding to all the tap coefficients) to directly obtain the nonlinear clipping indexes corresponding to the tap coefficients transmitted in the adaptation parameter set. The decoding side may decode the sixth index flag bit to determine whether, among the filter banks of the adaptation parameter set, there is at least one filter bank that includes the filter whose tap coefficients all correspond to the same nonlinear clipping indexes. If the sixth index flag bit is the first preset value, the third index flag bit corresponding to each filter bank may be continuously decoded to determine the filter whose first index flag bit is the first preset value from the filter bank whose third index flag bit is the first preset value, thereby inferring that the nonlinear clipping indexes of the filter whose first index flag bit is the first preset value are preset indexes. In this way, the nonlinear clipping indexes corresponding to the tap coefficients of the filters in the filter bank are obtained based on the tap coefficient information obtained by decoding the index flag bits.

In some embodiments, the filter flag bit further includes an eighth index flag bit, and the eighth index flag bit is configured for indicating the nonlinear clipping index shared by all tap coefficients of a corresponding adaptation parameter set.

In a case that the seventh index flag bit of the filter bank that is decoded by the decoding side is the first preset value, it may be determined that the nonlinear clipping indexes corresponding to all the tap coefficients of all the filters in the adaptation parameter set are all filter parameters with redundant data during transmission, thereby determining that the nonlinear clipping indexes shared by all the tap coefficients of all the filters in the adaptation parameter set are the eighth index flag bit, such as the nonlinear clipping index that is the eighth index flag bit whose value is 0, 1, 2, or 3. The nonlinear clipping indexes corresponding to the eighth index flag bit are the same as the nonlinear clipping indexes corresponding to all the tap coefficients of the filter bank.

In this way, by introducing the eighth index flag bit indicating the nonlinear clipping indexes corresponding to all the tap coefficients of the adaptation parameter set, the decoding indication accuracy is higher than that achieved by determining, as the preset index, the nonlinear clipping index of the adaptation parameter set in which all tap coefficients correspond to the same nonlinear clipping index.

In one example, a transmission process of syntax elements corresponding to the seventh index flag bit and the eighth index flag bit is shown in the following Table 11:

| | Descriptor |
|---|---|
| alf_data( ) { | |
| ... | |
| if( alf_comp_filter_signal_flag ) { | |
| ... | |
| alf_comp_num_alt_filters_minus1 | ue(v) |
| alf_alt_all_filt_clip_same | u(1) |
| if(alf_alt_all_filt_clip_same) | |
| alf_alt_all_filt_clip_index | u(2) |
| else | |
| alf_alt_has_filt_clip_all_same | u(1) |
| for(altIdx = 0; altIdx <= alf_comp_num_alt_filters_minus1; altIdx++){ | |
| alf_comp_clip_flag | u(1) |
| alf_comp_num_filters_signalled_minus1 | ue(v) |
| ... | |
| if(alf_alt_has_filt_clip_all_same && alf_comp_clip_flag) | |
| alf_has_filt_clip_all_same[altIdx] | u(1) |
| if(alf_has_filt_clip_all_same[altIdx]){ | |
| for( sfIdx = 0; sfIdx <= | |
| alf_comp_num_filters_signalled_minus1; sfIdx++ ) | |
| alf_filt_clip_all_same[altIdx][sfIdx] | u(1) |
| } | |
| for( sfIdx = 0; sfIdx <= alf_comp_num_filters_signalled_minus1; | |
| sfIdx++ ) | |
| alf_comp_coeff( ) | |
| if( alf_comp_clip_flag && !alf_alt_all_filt_clip_same) | |
| for( sfIdx = 0; sfIdx <= | |
| alf_comp_num_filters_signalled_minus1; sfIdx++ ) | |
| if(alf_filt_clip_all_same[altIdx][sfIdx]) | |
| alf_filt_same_clip_index[altIdx][sfIdx] | u(2) |
| else | |
| for( j = 0; j < filter_tap_num; j++ ) | |
| alf_comp_clip_idx[altIdx][ sfIdx ][ j ] | u(2) |
| ... | |
| } | |
| } | |
| } | |

where the seventh index flag bit alf_alt_all_filt_clip_same being 1 indicates that all filters in the filter bank supported by the current APS use the same nonlinear clipping index, and being 0 indicates that not all the filters in the filter bank supported by the current APS use the same nonlinear clipping index. The seventh index flag bit is set to 0 by default.

The eighth index flag bit alf_alt_all_filt_clip_index indicates the same nonlinear clipping index used by all the filters in the filter bank supported by the current APS.

The sixth index flag bit alf_alt_has_filt_clip_all_same being 1 indicates that, among the filter banks supported by the current APS, there is at least one filter bank that includes the filter using the same nonlinear clipping index. The sixth index flag bit being 0 indicates that none of the filters included in the filter banks supported by the current APS use the same nonlinear clipping indexes. The sixth index flag bit is set to 0 by default.

The third index flag bit alf_has_filt_clip_all_same [altIdx] being 1 indicates that the altIdx^{th} filter bank includes at least one filter whose tap coefficients all correspond to the same nonlinear clipping indexes. The third index flag bit being 0 indicates that the altIdx^{th} filter bank includes no filter whose tap coefficients use the same nonlinear clipping indexes. The third index flag bit is set to 0 by default.

The first index flag bit alf_filt_clip_all_same [altIdx] [sfIdx] being 1 indicates that all the nonlinear clipping indexes corresponding to the tap coefficients of the sfIdx^{th} filter in the altIdx^{th} filter bank are the same, and being 0 indicates that not all the nonlinear clipping indexes corresponding to the tap coefficients of the corresponding filter are the same. The first index flag bit is set to 0 by default.

The second index flag bit alf_filt_same_clip_index [altIdx] [sfIdx] indicates the nonlinear clipping index shared by the tap coefficients of the sfIdx^{th} filter in the altIdx^{th} filter bank.

In another example, a transmission process of the syntax elements corresponding to the seventh index flag bit and the eighth index flag bit is shown in the following Table 12:

| | Descriptor |
|---|---|
| alf_data( ) { | |
| ... | |
| if( alf_comp_filter_signal_flag ) { | |
| ... | |
| alf_comp_num_alt_filters_minus1 | ue(v) |
| alf_alt_all_filt_clip_same | u(1) |
| if(alf_alt_all_filt_clip_same) | |
| alf_alt_all_filt_clip_index | u(2) |
| else | |
| alf_alt_has_filt_clip_all_same | u(1) |
| for(altIdx = 0; altIdx <= alf_comp_num_alt_filters_minus1; altIdx++){ | |
| alf_comp_clip_flag | u(1) |
| alf_comp_num_filters_signalled_minus1 | ue(v) |
| ... | |
| if(alf_alt_has_filt_clip_all_same && alf_comp_clip_flag){ | |
| alf_filtset_all_filt_clip_same[altIdx] | u(1) |
| if(alf_filtset_all_filt_clip_same[altIdx]) | |
| alf_filtset_all_filt_clip_index[altIdx] | u(2) |
| else | |
| alf_has_filt_clip_all_same[altIdx] | u(1) |
| if(alf_has_filt_clip_all_same[altIdx]){ | |
| for( sfIdx = 0; sfIdx <= | |
| alf_comp_num_filters_signalled_minus1; sfIdx++ ) | |
| alf_filt_clip_all_same[altIdx][sfIdx] | u(1) |
| } | |
| } | |
| for( sfIdx = 0; sfIdx <= alf_comp_num_filters_signalled_minus1; | |
| sfIdx++ ) | |
| alf_comp_coeff( ) | |
| if( alf_comp_clip_flag && !alf_alt_all_filt_clip_same | |
| && !alf_filtset_all_filt_clip_same[altIdx]) | |
| for( sfIdx = 0; sfIdx <= | |
| alf_comp_num_filters_signalled_minus1; sfIdx++ ) | |
| if(alf_filt_clip_all_same[altIdx][sfIdx]) | |
| alf_filt_same_clip_index[altIdx][sfIdx] | u(2) |
| else | |
| for( j = 0; j < filter_tap_num; j++ ) | |
| alf_comp_clip_idx[altIdx][ sfIdx ][ j ] | u(2) |
| ... | |
| } | |
| } | |
| } | |

where the seventh index flag bit alf_alt_all_filt_clip_same being 1 indicates that all filters in the filter bank supported by the current APS use the same nonlinear clipping index, and being 0 indicates that not all the filters in the filter bank supported by the current APS use the same nonlinear clipping index. The seventh index flag bit is set to 0 by default.

The eighth index flag bit alf_alt_all_filt_clip_index indicates the same nonlinear clipping index used by all the filters in the filter bank supported by the current APS.

The sixth index flag bit alf_alt_has_filt_clip_all_same being 1 indicates that, among the filter banks supported by the current APS, there is at least one filter bank that includes the filter using the same nonlinear clipping index. The sixth index flag bit being 0 indicates that none of the filters included in the filter banks supported by the current APS use the same nonlinear clipping indexes. The sixth index flag bit is set to 0 by default.

The fourth index flag bit alf_filtset_all_filt_clip_same [altIdx] being 1 indicates that the tap coefficients of all the filters in the altIdx^{th} filter bank use the same nonlinear clipping index, and being 0 indicates that not all the tap coefficients of all the filters in the corresponding filter bank use the same nonlinear clipping indexes. The fourth index flag bit is set to 0 by default.

The fifth index flag bit alf_filtset_all_filt_clip_index [altIdx] indicates the same nonlinear clipping index used by all the filters in the altIdx^{th} filter bank.

The third index flag bit alf_has_filt_clip_all_same [altIdx] being 1 indicates that the altIdx^{th} filter bank includes at least one filter whose tap coefficients all correspond to the same nonlinear clipping indexes. The third index flag bit being 0 indicates that the altIdx^{th} filter bank includes no filter whose tap coefficients use the same nonlinear clipping indexes. The third index flag bit is set to 0 by default.

The first index flag bit alf_filt_clip_all_same [altIdx] [sfIdx] being 1 indicates that all the nonlinear clipping indexes corresponding to the tap coefficients of the sfIdx^{th} filter in the altIdx^{th} filter bank are the same, and being 0 indicates that not all the nonlinear clipping indexes corresponding to the tap coefficients of the corresponding filter are the same. The first index flag bit is set to 0 by default.

The second index flag bit alf_filt_same_clip_index [altIdx] [sfIdx] indicates the nonlinear clipping index shared by the tap coefficients of the sfIdx^{th} filter in the altIdx^{th} filter bank.

In some implementations, if the filter flag bit is a preset value, the filter parameter indicated by the filter flag bit is not signaled in the video bitstream.

Specifically, when the filter flag bit is the preset value (such as the first preset value or the second preset value), it indicates that the filter parameter indicated by the filter flag bit is a filter parameter with redundant data during transmission. In this case, the filter parameter with redundant data during transmission is implicitly transmitted, and the filter parameter is not signaled in the video bitstream, thereby reducing redundant data in the video bitstream.

For example, when the first tap flag bit is the first preset value, it indicates that all the tap coefficients of the filter corresponding to the first tap flag bit are 0. In this case, the tap coefficients of the filter corresponding to the first tap flag bit may not be signaled in the video bitstream, namely, they are implicitly transmitted. For another example, when the first index flag bit is the first preset value, it indicates that all the nonlinear clipping indexes corresponding to the tap coefficients of the filter corresponding to the first index flag bit are the same. In this case, the nonlinear clipping indexes of the filter corresponding to the first index flag bit may not be signaled in the video bitstream, namely, they are implicitly transmitted.

In some implementations, the filter flag bit includes at least one of a filter flag bit corresponding to the luminance component, a filter flag bit corresponding to the chrominance component, and a filter flag bit corresponding to the cross-component.

There are corresponding filters for the luminance component, the chrominance component, and the cross-component. Therefore, the filter flag bit may be introduced to perform decoding indication for the filter parameter, which has redundant data during transmission, of the filter corresponding to the luminance component, to reduce redundant data of the filter corresponding to the luminance component. The corresponding filter flag bit is introduced to perform decoding indication for the filter parameter, which has redundant data during transmission, of the filter corresponding to the chrominance component, to reduce redundant data of the filter corresponding to the chrominance component. The corresponding filter flag bit is introduced to perform decoding indication for a redundant parameter of the filter corresponding to the cross-component, to reduce redundant data of the filter corresponding to the cross-component.

Based on the method described in the foregoing embodiments, some embodiments further provides a video coding method. FIG. 17 is a schematic flowchart of a video coding method according to some embodiments. The method includes:

Operation 021: Acquire video data.

Operation 022: Perform coding and compression on the video data to obtain a video bitstream, the video bitstream including decoding indication information, the decoding indication information including at least one filter flag bit configured for indicating a filter parameter, the filter flag bit being determined based on tap coefficient information, and the tap coefficient information being determined based on the filter parameter.

A video coding process and a video decoding process are reversible.

Therefore, for syntax definitions involved in the video coding method provided in some embodiments of this application, refer to the embodiments of the video decoding method described above.

Based on the method described in the foregoing embodiments, some embodiments further provides a video decoding apparatus, configured to perform operations in the foregoing video decoding method. FIG. 18 is a schematic structural diagram of a video decoding apparatus 300 according to some embodiments. The video decoding apparatus 300 includes a first acquiring module 301 and a decoding module 302.

The first acquiring module 301 is configured to acquire a video bitstream, where the video bitstream includes decoding indication information, and the decoding indication information includes at least one filter flag bit configured for indicating a filter parameter.

The decoding module 302 is configured to determine tap coefficient information in the filter parameter based on a value of the filter flag bit; and determine the filter parameter based on the tap coefficient information.

Details of module units of the video decoding apparatus 300 are described in detail in the embodiments of the video decoding method.

Based on the method described in the foregoing embodiments, some embodiments further provides a video coding apparatus, configured to perform operations in the foregoing video coding method. FIG. 19 is a schematic structural diagram of a video coding apparatus 400 according to some embodiments. The video coding apparatus 400 includes a second acquiring module 401 and a coding module 402.

The second acquiring module 401 is configured to acquire video data.

The coding module 402 is configured to perform coding and compression on the video data to obtain a video bitstream, where the video bitstream includes decoding indication information, the decoding indication information includes at least one filter flag bit configured for indicating a filter parameter, the filter flag bit is determined based on tap coefficient information, and the tap coefficient information is determined based on the filter parameter.

In the embodiment of this application, the term “module” or “unit” refers to a computer program with a preset function or a part of the computer program and works, together with other related parts, to implement a preset target, and may be completely or partially implemented by using software, hardware (for example, a processing circuit or a memory) or a combination thereof. Similarly, one processor (or a plurality of processors or memories) may be configured to realize one or more modules or units. In addition, each module or unit may be a part of an integrated module or unit including the module or unit function.

In some embodiments, the video coding apparatus and the video decoding apparatus in some embodiments of this application may be an electronic device, or may be a component, such as an integrated circuit or a chip, in an electronic device. The electronic device may be a terminal or devices other than the terminal. For example, the electronic device may be a mobile phone, a tablet computer, a notebook computer, a palmtop computer, an in-vehicle electronic device, a mobile Internet device (MID), an augmented reality (AR)/virtual reality (VR) device, a robot, a wearable device, an ultra-mobile personal computer (UMPC), a netbook, or a personal digital assistant (PDA), or the like, or may be a server, a network attached storage (NAS), a personal computer (PC), a television (TV), a teller machine, a self-service machine, or the like. This is not limited in some embodiments of this application.

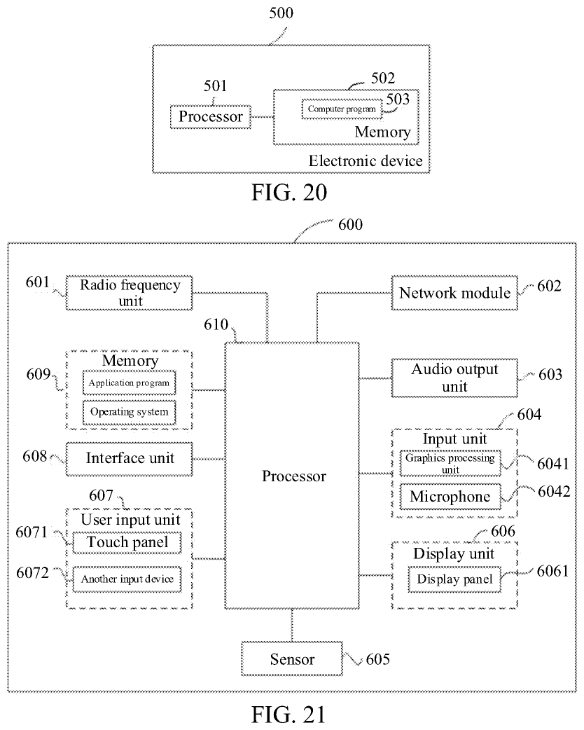

In some embodiments, as shown in FIG. 20, some embodiments further provides an electronic device 500, including a processor 501, a memory 502, and a computer program that is stored in the memory 502 and that can be run on the processor 501. The program, when executed by the processor 501, implements processes of the embodiments of the foregoing video decoding method and the video coding method to achieve the same technical effect.

The electronic device in some embodiments of this application includes the foregoing mobile electronic device and non-mobile electronic device.

FIG. 21 is a schematic diagram of a hardware structure of an electronic device according to some embodiments.

An electronic device 600 includes, but is not limited to, components such as a radio frequency unit 601, a network module 602, an audio output unit 603, an input unit 604, a sensor 605, a display unit 606, a user input unit 607, an interface unit 608, a memory 609, and a processor 610.

The electronic device 600 may further include a power supply (such as a battery) supplying power to the components. The power supply may be logically connected to the processor 610 by using a power management system, thereby implementing functions such as charging, discharging, and power consumption management by using the power management system. The structure of the electronic device shown in FIG. 21 does not constitute a limitation to the electronic device. The electronic device may include more or fewer components than those shown in the figure, may be formed by combining some components, or may have different component deployment. Details are not described again herein.

In some embodiments of this application, the input unit 604 may include a graphics processing unit (GPU) 6041 and a microphone 6042. The graphics processing unit 6041 processes image data of a static picture or a video that is obtained by an image capturing apparatus (such as a camera) in a video capture mode or an image capture mode. The display unit 606 may include a display panel 6061, which may employ a liquid crystal display and an organic light-emitting diode to configure the display panel 6061. The user input unit 607 includes at least one of a touch panel 6071 and another input device 6072. The touch panel 6071 is further referred to as a touchscreen. The touch panel 6071 may include two portions, namely, a touch detection apparatus and a touch controller. The another input device 6072 may include, but is not limited to, a physical keyboard, a functional key (such as a volume control key or a switch key), a track ball, a mouse, and a joystick. This is not repeated herein.

The memory 609 may be configured to store software programs and data. The memory 609 may mainly include a first storage area for storing a program or instructions and a second storage area for storing data, where the first storage area may store an operating system, an application by at least one function (such as a sound playback function and an image display function), and the like. Furthermore, the memory 609 may include a volatile memory or a non-volatile memory; or the memory 609 may include both the volatile memory and the non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM), a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), and a direct Rambus RAM (DR RAM). The memory 609 described in some embodiments of this application includes, but is not limited to, any suitable type of memory.

The processor 610 may include one or more processing units; and the processor 610 integrates an application processor and a modem. The application processor mainly processes operations involving an operating system, a user interface, an application, and the like. The modem mainly processes a wireless communication signal, such as a baseband processor. The foregoing modem may either not be integrated into the processor 610.

Some embodiments further provides a non-transient computer-readable storage medium having a computer program stored therein, the computer program, when executed by a processor, implementing the processes of the embodiments of the foregoing video decoding method and the foregoing video coding method to achieve the same technical effect.

The processor is the processor in the electronic device in the foregoing embodiment. The computer-readable storage medium may be a read-only memory (ROM), a random access memory (RAM), a magnetic disk, an optical disc, or the like.

Some embodiments further provides a computer program product, including a computer program, and the computer program, when executed by a processor, implementing the foregoing video decoding method and video coding method. The processor may be a processor in the electronic device in the foregoing embodiments. The computer program, when executed by a processor, implements the processes of the embodiments of the foregoing video decoding method and the foregoing video coding method to achieve the same technical effect.

Although the embodiments of this application have been shown and described, a person of ordinary skill in the art may understand that various changes, modifications, replacements, and variations may be made to these embodiments without departing from the principle and spirit of this application. The scope of this application is defined by the claims and their equivalents.

What is claimed is:

1. A video decoding method, performed by an electronic device, comprising:
acquiring a video bitstream including decoding indication information, wherein the decoding indication information includes at least one filter flag bit indicating a filter parameter of a filter, and wherein the filter parameter includes a tap coefficient and a nonlinear clipping index corresponding to the tap coefficient;
determining, based on a value of the at least one filter flag bit, tap coefficient information about the filter parameter;
determining the filter parameter based on the tap coefficient information, wherein: based on the at least one filter flag bit having a first preset value, the determining the filter parameter includes skipping receiving the tap coefficient information from the video bitstream and inferring at least a portion of the filter parameter, and
based on the at least one filter flag bit having a second preset value different from the first preset value, the determining the filter parameter includes decoding the tap coefficient information from the video bitstream to obtain the at least the portion of the filter parameter; and
performing adaptive loop filtering on a reconstructed picture using the filter configured by the filter parameter, to generate a filtered reconstructed picture for use as a reference picture in decoding a subsequent picture.

2. The video decoding method according to claim 1, wherein the filter has tap coefficients including the tap coefficient, wherein the at least one filter flag bit includes a first tap flag bit indicating whether the tap coefficients are all 0, wherein, based on the first tap flag bit having the first preset value, the tap coefficient information indicates that the tap coefficients are all 0; and wherein, based on the first tap flag bit having the second preset value, the tap coefficient information indicates that not all of the tap coefficients are 0.

3. The video decoding method according to claim 2, wherein the determining the filter parameter includes:
skipping receiving the tap coefficient information and inferring that the tap coefficients of the filter are all 0, based on the first tap flag bit indicating that the tap coefficients of the filter are all 0; and
decoding the tap coefficient information from the video bitstream to obtain the tap coefficients of the filter, based on the first tap flag bit indicating that not all of the tap coefficients of the filter are 0.

4. The video decoding method according to claim 1, wherein the filter is one of a plurality of filters divided into one or more filter banks, wherein the at least one filter flag bit includes a second tap flag bit indicating whether, in a filter bank of the one or more filter banks, there is at least one filter whose tap coefficients are all 0, wherein, based on the second tap flag bit having the first preset value, the tap coefficient information indicates that, in the filter bank, there is at least one filter whose tap coefficients are all 0; and wherein, based on the second tap flag bit having the second preset value, the tap coefficient information indicates that, in the filter bank, there is no filter whose tap coefficients are all 0.

5. The video decoding method according to claim 4, wherein the determining the filter parameter includes:
skipping receiving the tap coefficient information of the at least one filter and inferring that the tap coefficients of the at least one filter are all 0, based on the second tap flag bit indicating that, in the filter bank, there is the at least one filter whose tap coefficients are all 0; and
decoding the tap coefficient information from the video bitstream to obtain the tap coefficients of the filters in the filter bank, based on the second tap flag bit indicating that, in the filter bank, there is no filter whose tap coefficients are all 0.

6. The video decoding method according to claim 1, wherein the filter is one of a plurality of filters divided into one or more filter banks, wherein the one or more filter banks are located in an adaptation parameter set, wherein the at least one filter flag bit includes a third tap flag bit indicating whether, in the adaptation parameter set, there is at least one filter bank, of the one or more filter banks, that includes at least one filter whose tap coefficients are all 0, wherein, based on the third tap flag bit having the first preset value, the tap coefficient information indicates that, in the adaptation parameter set, there is the at least one filter bank that includes the at least one filter whose tap coefficients are all 0; and wherein, based on the third tap flag bit having the second preset value, the tap coefficient information indicates that, in the adaptation parameter set, there is no filter bank that includes any filter whose tap coefficients are all 0.

7. The video decoding method according to claim 6, wherein the determining the filter parameter includes:
skipping receiving the tap coefficient information of the at least one filter and inferring that the tap coefficients of the at least one filter are all 0, based on the third tap flag bit indicating that, in the adaptation parameter set, there is the at least one filter bank that includes the at least one filter whose tap coefficients are all 0; and
decoding the tap coefficient information from the video bitstream to obtain the tap coefficients of the plurality of filters in the adaptation parameter set, based on the third tap flag bit indicating that, in the adaptation parameter set, there is no filter bank that includes any filter whose tap coefficients are all 0.

8. The video decoding method according to claim 1, further including:
determining that nonlinear clipping indexes corresponding to tap coefficients are preset indexes, based on the tap coefficients being decoded as 0.

9. The video decoding method according to claim 1, wherein the at least one filter flag bit includes a first index flag bit indicating whether nonlinear clipping indexes corresponding to tap coefficients of the filter are all the same, wherein, based on the first index flag bit having the first preset value, the tap coefficient information indicates that the nonlinear clipping indexes are all the same; and wherein, based on the first index flag bit having the second preset value, the tap coefficient information indicates that not all of the nonlinear clipping indexes are the same.

10. The video decoding method according to claim 9, wherein the determining the filter parameter includes:
skipping receiving the tap coefficient information and inferring that the nonlinear clipping indexes are preset indexes, based on the first index flag bit indicating that the nonlinear clipping indexes are all the same; and
decoding the tap coefficient information from the video bitstream to obtain the nonlinear clipping indexes, based on the first index flag bit indicating that not all of the nonlinear clipping indexes are the same.

11. The video decoding method according to claim 1, wherein the at least one filter flag bit includes a first index flag bit and a second index flag bit, wherein the first index flag bit indicates whether nonlinear clipping indexes corresponding to tap coefficients of the filter are all the same, wherein the second index flag bit indicates a nonlinear clipping index shared by all of the tap coefficients of the filter, wherein, based on the first index flag bit having the first preset value, the tap coefficient information indicates that the nonlinear clipping indexes are all the same; and wherein, based on the first index flag bit having the second preset value, the tap coefficient information indicates that not all of the nonlinear clipping indexes are the same.

12. A video decoding apparatus, comprising:
at least one memory configured to store program code; and
at least one processor configured to read the program code and operate as instructed by the program code, the program code comprising:
acquiring code configured to cause at least one of the at least one processor to acquire a video bitstream including decoding indication information, wherein the decoding indication information includes at least one filter flag bit indicating a filter parameter of a filter, and wherein the filter parameter includes a tap coefficient and a nonlinear clipping index corresponding to the tap coefficient;
first determining code configured to cause at least one of the at least one processor to determine, based on a value of the at least one filter flag bit, tap coefficient information about the filter parameter;
second determining code configured to cause at least one of the at least one processor to determine the filter parameter based on the tap coefficient information, wherein:
based on the at least one filter flag bit having a first preset value, the determining the filter parameter includes skipping receiving the tap coefficient information from the video bitstream and inferring at least a portion of the filter parameter, and
based on the at least one filter flag bit having a second preset value different from the first preset value, the determining the filter parameter includes decoding the tap coefficient information from the video bitstream to obtain the at least the portion of the filter parameter; and
filtering code configured to cause at least one of the at least one processor to perform adaptive loop filtering on a reconstructed picture using the filter configured by the filter parameter, to generate a filtered reconstructed picture for use as a reference picture in decoding a subsequent picture.

13. The apparatus according to claim 12, wherein the filter has tap coefficients including the tap coefficient, wherein the at least one filter flag bit includes a first tap flag bit indicating whether the tap coefficients are all 0, wherein, based on the first tap flag bit having the first preset value, the tap coefficient information indicates that the tap coefficients are all 0; and
wherein, based on the first tap flag bit having the second preset value, the tap coefficient information indicates that not all of the tap coefficients are 0.

14. The apparatus according to claim 13, wherein the second determining code is further configured to cause at least one of the at least one processor to:
skip receiving the tap coefficient information and infer that the tap coefficients of the filter are all 0, based on the first tap flag bit indicating that the tap coefficients of the filter are all 0; and
decode the tap coefficient information from the video bitstream to obtain the tap coefficients of the filter, based on the first tap flag bit indicating that not all of the tap coefficients of the filter are 0.

15. The apparatus according to claim 12, wherein the filter is one of a plurality of filters divided into one or more filter banks, wherein the at least one filter flag bit includes a second tap flag bit indicating whether, in a filter bank of the one or more filter banks, there is at least one filter whose tap coefficients are all 0, wherein, based on the second tap flag bit having the first preset value, the tap coefficient information indicates that, in the filter bank, there is at least one filter whose tap coefficients are all 0; and wherein, based on the second tap flag bit having the second preset value, the tap coefficient information indicates that, in the filter bank, there is no filter whose tap coefficients are all 0.

16. The apparatus according to claim 15, wherein the second determining code is further configured to cause at least one of the at least one processor to:
skip receiving the tap coefficient information of the at least one filter and infer that the tap coefficients of the at least one filter are all 0, based on the second tap flag bit indicating that, in the filter bank, there is the at least one filter whose tap coefficients are all 0; and
decode the tap coefficient information from the video bitstream to obtain the tap coefficients of the filters in the filter bank, based on the second tap flag bit indicating that, in the filter bank, there is no filter whose tap coefficients are all 0.

17. The apparatus according to claim 12, wherein the filter is one of a plurality of filters divided into one or more filter banks, wherein the one or more filter banks are located in an adaptation parameter set, wherein the at least one filter flag bit includes a third tap flag bit indicating whether, in the adaptation parameter set, there is at least one filter bank, of the one or more filter banks, that includes at least one filter whose tap coefficients are all 0, wherein, based on the third tap flag bit having the first preset value, the tap coefficient information indicates that, in the adaptation parameter set, there is the at least one filter bank that includes the at least one filter whose tap coefficients are all 0; and wherein, based on the third tap flag bit having the second preset value, the tap coefficient information indicates that, in the adaptation parameter set, there is no filter bank that includes any filter whose tap coefficients are all 0.

18. The apparatus according to claim 17, wherein the second determining code is further configured to cause at least one of the at least one processor to:
skip receiving the tap coefficient information of the at least one filter and infer that the tap coefficients of the at least one filter are all 0, based on the third tap flag bit indicating that, in the adaptation parameter set, there is the at least one filter bank that includes the at least one filter whose tap coefficients are all 0; and
decode the tap coefficient information from the video bitstream to obtain the tap coefficients of the plurality of filters in the adaptation parameter set, based on the third tap flag bit indicating that, in the adaptation parameter set, there is no filter bank that includes any filter whose tap coefficients are all 0.

19. The apparatus according to claim 12, wherein the program code further comprises:
index code configured to cause at least one of the at least one processor to determine that nonlinear clipping indexes corresponding to tap coefficients are preset indexes, based on the tap coefficients being decoded as 0.

20. A non-transitory computer-readable storage medium, storing computer code which, when executed by at least one processor, causes the at least one processor to at least:
acquire a video bitstream including decoding indication information, wherein the decoding indication information includes at least one filter flag bit indicating a filter parameter of a filter, and wherein the filter parameter includes a tap coefficient and a nonlinear clipping index corresponding to the tap coefficient;
determine, based on a value of the at least one filter flag bit, tap coefficient information about the filter parameter;
determine the filter parameter based on the tap coefficient information, wherein:
based on the at least one filter flag bit having a first preset value, the determining the filter parameter includes skipping receiving the tap coefficient information from the video bitstream and inferring at least a portion of the filter parameter, and
based on the at least one filter flag bit having a second preset value different from the first preset value, the determining the filter parameter includes decoding the tap coefficient information from the video bitstream to obtain the at least the portion of the filter parameter; and
perform adaptive loop filtering on a reconstructed picture using the filter configured by the filter parameter, to generate a filtered reconstructed picture for use as a reference picture in decoding a subsequent picture.
